(19) United States
(12) Patent Application Publication
(10) Pub. No.: US 2009/0051759 A1
(43) Pub. Date: Feb. 26, 2009

(54) EQUIPMENT AND METHODS FOR THE SYNCHRONIZATION OF STEREOSCOPIC PROJECTION DISPLAYS

(76) Inventors: Sean M. Adkins, Kamuela, HI (US); Matthew O'Dor, Toronto (CA)

Correspondence Address: JOHN S. PRATT, ESQ;KILPATRICK STOCKTON, LLP, 1100 PEACHTREE STREET, ATLANTA, GA, 30309, US

(21) Appl. No.: 11/915,425

(22) PCT Filed: May 30, 2006
(86) PCT No.: PCT/US2006/020940

§ 371 Date: May 12, 2008

Related U.S. Application Data
(60) Provisional application No. 60/685,517, filed on May 27, 2005.
(60) Provisional application No. 60/756,593, filed on Jan. 4, 2006.

(51) Int. Cl. H04N 13/04

(52) U.S. Cl. 348/53; 348/54

(57) ABSTRACT

Equipment and methods for the synchronization of stereoscopic projection displays are described. One projection system described includes at least one projector for projecting alternate left and right eye stereoscopic images for viewing with stereoscopic viewing eyewear, and further includes an image data storage and retrieval device capable of outputting an image data stream in a first image data format, a projector capable of producing displayed image frames for viewing and having at least one spatial light modulator and a signal processing unit capable of receiving the image data stream and converting the first format to a second image data format, wherein the second image data format is compatible with the at least one spatial light modulator, and a synchronizing device comprising a frame synchronizing signal detector, a time delay unit, and a synchronizing signal transmitter, wherein the frame synchronizing signal detector is capable of generating a synchronization signal for synchronizing the eyewear with the displayed image frames, the synchronizing signal transmitter is capable of transmitting the synchronization signal, and the time delay unit is capable of causing a time delay for transmission of the synchronizing signal based at least in part on either or both of the first image format and the second image data format.

### RELATED APPLICATIONS

This application claims priority to U.S. Provisional Application No. 60/685,517, filed May 27, 2005, entitled “Equipment and Methods for the Synchronization of Stereoscopic Projection Displays” and U.S. Provisional Application No. 60/756,593, filed Jan. 4, 2006, entitled “Equipment and Methods for the Synchronization of Stereoscopic Projection Displays”, which are incorporated herein in their entirety by this reference.

### FIELD OF THE INVENTION

This invention relates to the projection of stereoscopic motion pictures and more specifically to methods and apparatus for synchronizing alternate eye stereoscopic projection displays with special purpose eyewear incorporating active occluding shutters or with an electrically switchable electro-optical polarizer placed in the optical path of the projector operating in conjunction with special purpose eyewear incorporating polarizing lenses.

### BACKGROUND OF THE INVENTION

In a method known in the prior art to create the illusion of a three dimensional or stereoscopic image, the viewer is shown two photographic images, one for the left eye and one for the right eye. The two images are of the same scene, but taken by lenses at two different viewpoints, separated by a horizontal distance that approximates the separation of the viewer's eyes, in effect capturing the scene with binocular disparity that corresponds to what the viewer would see if the viewer was actually present and viewing the scene being photographed.

By photographing a sequence of images at regular time intervals the motion of objects in the scene may be recorded. The illusion of motion can then be created by displaying the sequence of images at a constant rate similar to that used to photograph the sequence. Of course in order to preserve smooth motion the time intervals between the images or frames of the sequence must be short enough to ensure that the viewer perceives the motion as continuous even though the sequence actually includes discrete frames. In the art of such motion pictures the commonly accepted frame interval needed to create an illusion of smooth motion corresponds to 1/24 of a second, resulting in a frame rate of 24 frames per second (fps).

If two motion picture sequences are photographed at the same time from two different viewpoints as described above, then a motion picture may be created that provides the viewer with the illusion of a three dimensional moving image. In order to view such a sequence a number of methods have been described in the prior art. Additionally methods other than photography such as television or video recording may be employed to record stereoscopic motion pictures. In addition to motion picture film projection, television or video displays including direct view and projection systems may also be employed to display stereoscopic motion pictures.

In order to create the three dimensional illusion it is necessary to employ some means to display the two motion picture sequences representing the right and left viewpoints. The sequence must be displayed as right and left pairs of images, with one image of each pair being the image intended for the viewer's right eye and the other image of each pair being the image intended for the viewer's left eye.

In the prior art two general categories of methods for accomplishing this object are described. In one category are methods that alternately display the image intended for the right eye and the image intended for the left eye. These methods are commonly referred to as alternate eye stereoscopic displays or projection systems.

For motion picture film alternate eye stereoscopic projection may be accomplished using the methods and apparatus described in U.S. Pat. No. 5,002,387 to Baljet et al., which describes a projection system where the image intended for the right eye is projected in alternation with the image intended for the left eye and by means of special purpose alternate eye projection viewing eyewear or “shutter glasses” equipped with an occluding shutter such as lens for each eye that can be switched between opaque and transparent states so that the lens over the right eye can be made transparent only when the image intended for the right eye is being projected onto the screen, and the lens over the left eye can be made transparent only when the image intended for the left eye is being projected onto the screen. Because the lenses of the shutter glasses do not switch instantaneously between the opaque and transparent states, and because of inevitable tolerances and variations in the construction and timing of the projection system, Baljet et al. describes methods and apparatus that operate to ensure that a signal transmitted by the projection system to the glasses is properly timed in relation to the switching of images by the projector.

Alternatively an electrically switchable electro-optical polarizer (or electro-optical polarizing element) capable of altering the polarization of light between two different polarization states in response to an electrical signal may be placed in the display optical path such as after the faceplate of a cathode ray tube display or after the lens of a projector. Apparatus of this type is described in U.S. Pat. No. 4,281,341 to Byatt. Improvements to this apparatus are described in U.S. Pat. No. 6,975,345 to Lipton et al. A device providing this function is marketed under the registered trademark “Zscreen”.

The polarizing element is controlled in synchronization with the right/left alternating image sequence to encode the display light for each of the alternate frames with two different polarizations. The viewer then wears special eyewear equipped with polarizing lenses so that the image encoded for the right eye is seen only with the right eye and the image encoded for the left eye is seen only with the left eye.

In the other category are methods in which the two images are displayed simultaneously, often using two projectors, and a means is employed to encode the right and left images using for example distinct color bands or different polarizations of the light from the display or projectors. The viewer then wears special eyewear equipped with the appropriate color band pass filters or polarizing lenses so that the image encoded for the right eye is seen only with the right eye and the image encoded for the left eye is seen only with the left eye.

U.S. Pat. No. 4,562,463 to Lipton describes methods whereby stereoscopic motion picture sequences may be displayed using the alternate eye method in a television system, in particular a conventional 60 field per second interlaced video system, known in the U.S. as the NTSC system. U.S. Pat. No. 4,562,463 points out the need to synchronize the shutter glasses or the electro-optical polarizing element placed in front of the display or projection lens to the alternate eye sequence.

It is also necessary to ensure that the right and left pairs of images are displayed in the proper spatial relationship or convergence. This requires that the vertical alignment of the two images be correct to present the original scene with perfect vertical alignment of corresponding features in the two images. This also requires that the offset between the centers of the two images be correct for the disparity present in the images due to the horizontal spacing of the two image viewpoints used in the original photography. U.S. Pat. No. 4,562,463 describes electronic shifting of the position of the image on a cathode ray tube display to achieve this convergence. U.S. Pat. No. 7,002,618 to Lipton et al. describes a means to compensate for image misalignment due variations in the response of the display monitor to the vertical frame rate doubling peculiar to the techniques of the disclosure. In this case the compensation is described as dynamic adjustment of the blanking area in the video signal.

Another problem encountered in alternate eye stereoscopic displays or projection systems is the need to maintain the correct correspondence or phase between the alternating right and left image sequence in the motion picture and the switching of the states of the two lenses in the shutter glasses or the polarization state changes in the electro-optical polarizing element placed in front of the display or projection lens. It is desirable to provide a means to ensure that when the image intended for the right eye is being displayed that the shutter over the right eye is open and the shutter over the left eye is closed, and where an electro-optical polarizing element placed in front of the display or projection lens is used that it is in the correct state to ensure that the right eye of the viewer sees the correct image.

U.S. Pat. No. 4,979,033 to Stephens describes a method for using video field identification in an interlaced video system to determine the correct image sequence by identifying the first and second fields of each video frame and assuming that the first field always contains the image intended for the left eye. The synchronizing signal generated to switch the shutter glasses can then be correctly phased to ensure that the left eye of the viewer always sees the image intended for the left eye and the right eye of the viewer always sees the image intended for the right eye.

U.S. Pat. No. 5,572,250 to Lipton et al. describes an alternative means suited to any format of video stream or computer data which encodes identifying information in the image sequence to unambiguously identify left or right image frames. In this method specific pixels on specific image lines are set to certain easily detected color values and the presence of these values on specific lines is used to identify the image frame as left or right and in turn determine the correct image sequence. This method has the limitation that it relies on special processing of the image sequence, and subsequent processing may alter or obliterate the encoded information. Additionally the image is adulterated by the setting of specific image lines in one image of the pair to fixed color values, and the need to avoid these values in the corresponding image of the pair so that false encoding does not occur. These adulterations may be annoying to the viewer.

U.S. Pat. No. 5,821,989 to Lazzaro et al. generalizes the method of U.S. Pat. No. 4,979,033 to all forms of interlaced video signals including those generated by common computer display formats such as VGA and SVGA. A method is also described to “anticipate” the desired state of the shutter glasses control signal in order to ensure that the shutters are in the correct state when the next frame is displayed. As is later explained this is necessary to compensate for delays that may occur in the switching of the shutters. For computer software generated or processed image sequences, Lazzaro et al. describe a method to correct the “anticipation” if the result of software timing is such that the alternate eye sequence is interrupted due to the next alternate eye frame not being processed in time for the display frame rate in use.

U.S. Pat. No. 5,481,321 to Lipton describes a method for maintaining the correct right and left image correspondence applicable to simultaneous motion picture film projection of optically encoded left and right image pairs where polarization is used and the viewer wears special purpose eyewear incorporating polarizing lenses. Identifying information is included on every frame of either the right or left image and when this is detected by a sensor in the projector the polarizing element placed in front of the projection lens or lenses is altered electrically or mechanically to be in the correct state to properly encode the frame pairs to ensure that the left eye of the viewer always sees the image intended for the left eye and the right eye of the viewer always sees the image intended for the right eye.

U.S. Pat. No. 4,870,486 to Nakagawa et al. describes a method for identifying the left and right image frames in a sequence to aid in maintaining the correct right and left image correspondence in a video display system. This is accomplished by reserving a small portion of the image area and using a specific intensity to trigger a photodetector observing the correct portion of the image in order to identify a frame as either the left or right member of each pair. This method has the limitation that it relies on special processing of the image sequence, and subsequent processing may alter or obliterate the encoded information. Additionally, reserving a portion of the displayed image and setting that portion to a specific intensity value in one image of the pair adulterates the image. Further adulteration occurs due to the need to avoid similar values in the same portion of the corresponding image of the pair to avoid false encoding. These adulterations may be annoying to the viewer.

In order to make the shutter glasses convenient to wear it is desirable that the switching signal be transmitted remotely to the glasses using some form of wireless radio frequency or optical communications. U.S. Pat. No. 4,424,529 to Roese et al. describes apparatus for transmitting a synchronizing signal to shutter glasses using wireless communications. The transmitter of Roese et al. uses the identification of the first and second, or odd and even, fields in an interlaced video system to establish the left and right image sequence. The transmitter then encodes the left and right switching information in the transmitted synchronization signal in order to ensure that the glasses shutters assume the correct state. Since the relationship between first and second fields and left and right images is arbitrary the disclosure also describes provisions for inverting the relationship between fields and the switching states of the lenses in the shutter glasses.

U.S. Pat. No. 4,967,268 to Lipton et al. describes improvements to the receiving circuitry of the shutter glasses including the method of encoding the left and right switching information in the synchronizing signal to the glasses.

In the prior art related to the control of the shutter glasses the communications device sends an eyewear switching signal that is synchronized to the alternation of the projector or display between left and right images. The intent of this synchronization is to ensure that when the image intended for the left eye is projected that the left lens of the shutter glasses is transparent, and the right lens of the shutter glasses is opaque. Similarly when the image intended for the right eye is projected the right lens of the shutter glasses should be transparent, and the left lens of the shutter glasses is opaque. The switching of the glasses is assumed to be instantaneous, or at least rapid enough that no error occurs between the timing of the switching of the glasses and the changing of the display from the left image to the right image in each pair of an image sequence and then back to the left image of the next pair in the sequence and so on. Similarly, the switching of an electro-optical polarizing element placed in front of the display or projection lens must be properly timed to ensure that light from the display or projector that is allowed to enter a given polarization state corresponds to the image intended for the viewer's eye equipped with the polarizing lens for that polarization state.

Delay or lag in the response of the shutter glasses or the response of an electro-optical polarizing element placed in front of the display or projection lens to the synchronizing signal will cause an error in the timing between the switching of the shutter glasses or electro-optical polarizing element and the changing of the display from one image to the next. If this results in the displayed image changing before the shutters or electro-optical polarizing element have fully changed state then each eye of the viewer will see some of the image intended for the other eye. The result in a phenomenon commonly referred to as ghosting or crosstalk and it diminishes the quality of the stereoscopic effect and is often annoying to the viewer.

In the prior art it is assumed that an alternate eye stereoscopic display will regularly and rapidly switch from one image to the next. In practice the means used to accomplish this switching will determined the nature of the transition from one image to the next, and in any case this will inevitably not be instantaneous as some form of mechanical, electrical or electro-mechanical process will be required to present each image for display. In U.S. Pat. No. 5,002,387 to Baljet et al., the FIG. 3a illustrates the manner in which the brightness of each projected image rises and falls due to the action of the light shutter in the projector that is used to cut off the light from the film frame and projection lens while the film is moved from one frame to the next. The switching signal for the shutter glasses or an electro-optical polarizing element placed in front of the display or projection lens must account for the rise and fall time of the image brightness at the image transitions in order to prevent the viewer from experiencing crosstalk between the left and right images.

One method that can be employed to compensate for crosstalk due to the rise and fall time of the image brightness at the image transitions is to reduce the time each lens of the shutter glasses is transparent in order to ensure that each lens is transparent only during the time the image is displayed. That is by using a duty cycle of less than 50% for the transparent state of each shutter in the glasses an interval may be introduced where both lenses of the shutter glasses are opaque, ensuring that the viewer does not see the incorrect image due to the finite rise and fall times of the displayed image transition. A method for accomplishing this with shutter glasses is described in U.S. Pat. No. 5,717,412 to Edwards. As can be appreciated this method may eliminate crosstalk, but has the limitation that it also acts to reduce the brightness of the image seen by each eye because each lens of the shutter glasses are transparent for some time less than the time during which each image in the sequence is illuminated by the projector. It can also be appreciated that this method is applicable only to shutter glasses systems capable of separately controlling the state of each lens. In a system using a switchable electro-optical polarizing element placed in front of the display or projection lens the electro-optical polarizing element can only be in one polarizing state or the other, and this does not allow a state where no image light will reach the eyes of the viewer except for the dark time provided by the projector's light cutoff shutter or the blanking period of a display such as a cathode ray tube.

Another source of crosstalk is due to the finite switching time of the shutter employed in the shutter glasses or the finite switching time of an element with electrically alterable polarization placed in front of the display or projection lens. Depending on the method employed the shape and time of the transition between opaque and transparent (the shutter glasses rise time) and the shape of the transition between transparent and opaque (the glasses shutter fall time) may not match either the shape or the duration of the rise and fall time of the image brightness for the image transitions from a projector or display. Similarly the shape and time of the transition between polarizing states for an electro-optical polarizing element placed in front of the display or projection lens may not match either the shape or the duration of the rise and fall time of the image brightness for the image transitions of the projector or display. In both cases the solution to such imperfect matching is to introduce some blanking or dead time between image transitions. This can be accomplished by reducing the duty cycle of each projected or displayed image to be within the time required for the shutter glasses or the electro-optical polarizing element placed in front of the display or projection lens to fully change from one state to another. Alternatively where shutter glasses are employed the method of U.S. Pat. No. 5,717,412 to Edwards may be used to reduce the duty cycle of the transparent state of each shutter glasses lens to be within the time required for the transition between each projected or displayed image as determined by the rise and fall time of the image brightness at the image transitions from a projector or display. As can be appreciated these methods may eliminate crosstalk, but both have the limitation that they also act to reduce the brightness of the image seen by each eye because of the reduction of either the viewing or the display duty cycles.

In every case the problem may be reduced by ensuring that the shutter glasses or the electro-optical polarizing element placed in front of the display or projection lens switch between states as rapidly as possible.

In the prior art, the desirability of shutter glasses capable of rapid switching has been recognized. U.S. Pat. No. 4,698,688 to Milgram discloses a type of shutter that can alternate between a transparent state and a scattering state. The scattering state can be used to obscure the view of a display or projection screen, and a pair of such shutters mounted in viewing glasses can implement shutter glasses needed to control the left and right eye views of an alternate eye stereoscopic display. The shutter in Milgram is described as being capable of very fast switching between the scattering and transparent states. This is thought to be of benefit in alleviating the requirement for reduction of the duty cycle of either the shutter glasses or the projected or displayed images.

Milgram discloses the necessity of adjusting the timing of the transition to the scattering state for the shutter by advancing the time when this transition is effected with respect to the image transition of the display in order to allow for the longer time required by the shutter to enter the scattering state. This is similar to the shutter glasses lens turn-on and turn-off time accommodation described in U.S. Pat. No. 5,821,989 to Lazzaro et al. where the glasses switching signal pulse width may be adjusted within each image display time. Milgram does not describe a means for accomplishing this timing adjustment, but the methods of either U.S. Pat. No. 5,002,387 to Baljet et al. or U.S. Pat. No. 5,717,412 to Edwards may be applied to accomplish the required timing adjustment.

International Patent Application WO 94/10636 to Needle et al. discloses adding a delay to the timing of the shutter glasses “strobe” or switching signal in order to shift the phase of this signal to compensate for propagation delay of the switching signal and the finite switching time of the shutter glasses.

In the U.S. Patent Application 2004/0233527 to Palovuori a method is described for controlling the light source of a projector using a liquid crystal (LC) spatial light modulator (SLM). The light source is turned on and off in a manner that acts in the same way as the use of a shutter to cut off the light in a film projector during the time the film is advanced to the next frame. In Palovuori the projection light source is turned off during the time that the LC SLM is updated with the next image frame, preventing the viewer from seeing the image transition. In a system where two projectors are used for alternate eye stereoscopic projection, one projector corresponds to the left eye image and one projector corresponds to the right eye image. The image sequence then alternates between the two projectors with each projector displaying a black frame during the time the other projector is displaying an image. Due to finite time being required for updating of the LC SLM, crosstalk can occur if the shutter glasses duty cycle is not less than the duty cycle of each displayed image. In Palovuori switching of the projection light source on and off is used to reduce the duty cycle of each displayed image to be less than the frame time in order to ensure that the finite time for transition of the LC SLM in each projector between displayed frames and black frames does not result in crosstalk between the left and right eye images. As can be appreciated the method of Palovuori may also be applied to compensate for crosstalk arising from delays in the state changes of an electro-optical polarizing element placed in front of the display or projection lens. As can also be appreciated the method of Palovuori has the defect of reducing the duty cycle of each displayed image to less than the frame time and therefore reducing the brightness of the image. The method of Palovuori also requires a frame rate that is high enough that the off times of the lamps in the projectors do not result in visible flicker that may be annoying to the viewer.

In a motion picture film projection system it is common for the projected frame rate to be constant, usually 24 frames per second (fps). In order to conceal the motion of the image when the projection film is advanced a shutter is used to block the projection light from reaching the film. At the normal 24 fps rate of film projection the change in brightness due to the shutter is below the critical flicker frequency. The critical flicker frequency is the frequency for a flashing light above which most viewers will perceive the flashing light as continuously illuminated. In order to avoid the perception of flicker due to the action of the shutter, the shutter is made to block the light twice in each frame time, resulting in the frame being illuminated twice, in this case at a rate of 48 frames per second. During one of the times the light is blocked the film remains stationary, and during the other time the film is moved to the next frame. The resulting changes in brightness due to the shutter now occur at a frequency above that required for most viewers to perceive the illumination of the image as continuous rather than flickering.

For an alternate eye stereoscopic projection system the images may be similarly projected, but in this case two frames, one intended for the left eye, and one intended for the right eye must be shown in every 1/24 second interval. In order to avoid the perception of flicker a system using two projection films is preferred, one for the image sequence intended for the left eye, and one for the image sequence intended for the right eye. This allows the two image sequences to be projected using the same double illumination pattern described above, but with the shutters 180 degrees out of phase between the two projectors. This results in a sequence of LRLR or RLRL where each image is presented twice in each 1/24 second frame time.

It is a characteristic of motion picture projectors that the time required for advancing the film from one image to the next in a sequence is a small, fixed amount of the time between each frame. This results in a system with constant and predictable behavior, subject to the inevitable tolerances and variations in the construction and timing of the projection system, and subject to mechanical wear during the operating lifetime of the projection system.

For television systems similar considerations apply to the frame rate of image sequences. In television an additional consideration was applied in the early design of electronic television systems to harmonize the frame rate with the AC power line frequency in order to avoid problems with electromagnetic interference such as noise from power supplies in the television system that used rectified AC line power and from other AC powered equipment. Synchronization with the AC power line also reduces the possibility of illumination flicker being recorded by the camera system due to the AC line powered lighting used to illuminate the scene being photographed. This resulted in 60 Hz being selected as the field rate for television in North America, and 50 Hz being selected as the field rate for television in Europe.

In the early design of electronic television systems it was necessary to reduce the frequency of the horizontal scanning system in order to lower the performance demands on the scanning circuitry used in the receivers and television cameras and this was accomplished by using interlaced horizontal scanning of the picture, where every other horizontal line is scanned in each field time, with the first field scanning all of the odd numbered lines in the picture and the second field scanning all of the even numbered lines in the picture. The frame rate of an interlaced scanning television system is one half of the field rate or 30 Hz in North America. The cathode ray tube for the image display is equipped with phosphors that continue to glow after being scanned, and this persistence allows the system to operate at a frame rate below the critical flicker frequency while avoiding noticeable flicker.

In alternate eye stereoscopic systems for television it was common to employ the odd field of each television frame for the image intended for one eye (either left or right) and the even field of each television frame for the image intended for the other eye. This results in a reduction in the vertical resolution of the picture, and also allows flicker to be perceived due to the fact that the shutters in the viewing glasses each allow viewing of only one of the two fields at a rate of 30 Hz. In U.S. Pat. No. 4,523,226 to Lipton et al. the vertical frame rate of the television system is doubled resulting in a frame rate of 60 Hz for each field, eliminating the perceived flicker.

In later embodiments a field store is used in conjunction with the display to allow the use of conventional tape recording equipment with a 30 Hz frame rate. Each field is stored and presented on a special display monitor capable of a 60 Hz frame rate. Each image pair is therefore presented two times for every frame coming from the videotape, resulting in the alternate eye shutters operating at a 60 Hz rate and therefore eliminating the perceived flicker.

In U.S. Pat. No. 4,979,033 to Stephens, a method of brightness limiting is proposed to reduce the perception of flicker in alternate eye systems operating with a 30 Hz frame rate. This method attempts to exploit the observation that the critical flicker frequency is proportional to the logarithm of the luminance of the stimulus or:

f=a log L+b,

where L is the stimulus luminance, and a and b are constants. The brightness limiter uses analog processing techniques to compress the brightness range of a video signal in order to limit the displayed brightness without clipping any of the gray scale range of the image.

In U.S. Pat. No. 6,088,052 to Guralnick, an analog delay line or line store is used to allow each scan line of an alternate eye image sequence to be repeated. This eliminates the increased spacing that may be visible between scan lines in a system that uses the odd field of each television frame for the image intended for one eye (either left or right) and the even field of each television frame for the image intended for the other eye. This does not increase the vertical resolution of the picture, but it may reduce the visibility of the scan lines, particularly on larger display screens viewed at close distances.

With the advent of personal computer systems the storage and display of alternate eye stereoscopic images using a computer is possible. This allows considerable flexibility in the image format, display frame rate and so on. In U.S. Pat. No. 5,821,989 to Lazzaro et al. the problem of automatically detecting the synchronization mode of the computer video output is considered and apparatus is described that is intended to decode various computer video formats and properly synchronize shutter glasses.

In U.S. Pat. No. 6,765,568 to Swift et al. a multipurpose stereoscopic media format is described and consideration is given to ensuring that an alternate eye stereoscopic sequence is properly displayed with respect to the sequencing of the left and right eye views. Additionally methods are described for reducing crosstalk by reducing the brightness of selected areas of the display where there is high contrast between corresponding areas in the left and right image pair. Methods are also described to compensate images for the loss of brightness due to the shutter glasses. All of these methods rely on the computer processing of the image sequence prior to display. The patent does not contemplate the time delays that will result from this image processing, delays which may have an effect on the synchronization of the images with respect to the signal used to control the switching of the shutter glasses.

Similarly, U.S. Pat. No. 7,002,618 to Lipton et al. describes a method for playback of stereoscopic media from a Digital Versatile Disk (DVD) format. The DVD format is limited to 30 Hz frame rates, and a personal computer is used to play the DVD. Special software is used to display the stereoscopic images at two times the frame rate to avoid the perception of flicker in the manner described above. Lipton does not contemplate the effect of the image processing in the computer on the synchronization of the images with respect to the signal used to control the switching of the shutter glasses.

U.S. Patent Application No. 2002/0154145 to Isakovic et al. describes a system where multiple image processing computers, driving multiple stereoscopic displays are responsible for computing various parts of a scene. In this system it is desirable that all of the displays change from one computed scene to the next, and where alternate eye stereoscopic displays are used, change from the left eye image to the right eye image and so on in synchronization. Isakovic et al. describe a computer data network based communications scheme to implement such synchronization. An apparatus is described in FIG. 6 of the application that acts to cause regular switching of a single video display system between left and right images stored in a frame buffer. A synchronization signal is also output to shutter glasses to coordinate switching of the shutter glasses with the image display.

Isakovic et al. accommodates processing delays that may occur in the multiple image processing computers by using a system of computer data network based communications to ensure that all image processing computers signal ready to a master computer that in turn coordinates the changing of the image on all of the stereoscopic displays in unison. Isakovic et al. does not disclose how the left/right image switching of multiple alternate eye stereoscopic displays is coordinated. Isakovic et al. also does not describe any method for ensuring that each new image is presented at a regular frame rate sufficient for the perception of smooth continuous motion as is required for a motion picture presentation.

U.S. Patent Application No. 2003/0112507 to Divelbiss et al. describes apparatus for the display of stereoscopic images adapted to a SLM known as a Digital Micro-mirror Device or DMD. Divelbiss et al. describe a multiplicity of stereoscopic image data formats, frame buffering and image processing techniques to display such images as stereoscopic image pairs using DMD based displays with either alternate eye or polarization encoding methods. Although Divelbiss et al. rely on processing that introduces between one and four frames of delay between the input image data playback and the display, the application fails to describe a method to address the synchronization problems for alternate eye stereoscopic displays that will arise due to delays caused by the extensive frame buffering described in the specifications. It appears that the inventors assume that precise synchronization can be maintained throughout the buffering and processing operations described in the patent application. In FIG. 15 of the application a “3D field signal” is shown as being generated by a microprocessor. No compensation for the delays in the DMD image processing chain immediately above it are contemplated or described. The application emphasizes that the output frame rate be made independent of the input frame rate, but the application fails to specify the necessity of coordinating the switching of shutter glasses in an alternate eye system with the output frame rate.

Prior to the development of image processing computers and the application of image processing techniques to the display of images, there was essentially no delay between the timing of a video input to a display system and the presentation of the output on the display. In both video and film displays the frame rate is generally held constant. In film displays by virtue of the tightly sequenced mechanical operation of a film projector, alternate eye stereoscopic film projection has a constant frame rate and essentially no delay between the timing of a signal developed from the projector mechanism to control the shutters in the shutter glasses used in alternate eye stereoscopic projection and the display of the image.

In the prior art, the problem of accommodating various delays in the switching of the shutters in the shutter glasses used in alternate eye stereoscopic display systems has been contemplated in the context of the prior art of stereoscopic video and film displays, all of which rely on a the existence of a constant or minimal delay in the signal path between the image source and the image display.

In systems where image-processing computers are used the prior art has failed to contemplate the problems of synchronization of the switching of the shutters in the shutter glasses used in alternate eye stereoscopic display systems with the image display where delays due to image processing may vary due to the nature of the image being processed or the operations performed in the processing.

It is now becoming common to use other kinds of display systems such as systems based on digital signaling for the transmission of image sequences, and digital storage means for the storage and retrieval of images, and on devices such as SLMs for the projection display of image sequences.

A SLM includes a two dimensional array of modulating elements or pixels, and by means of various control signals each pixel modulates the flux of a corresponding part of the light to be projected so as to form the desired pattern of pixel brightnesses that correspond to the image to be projected. Various types of SLM devices may be employed including DMDs and reflective or transmissive liquid crystal devices. Multiple SLM devices may be employed in various configurations to produce color displays, and a single SLM may be combined with a color filter wheel to produce a color display.

It is a characteristic of SLM devices that they are only capable of displaying an image that is formatted to have exactly the same or fewer pixels as the number possessed by the SLM. In order to produce an image of the highest quality it is desirable that all of the available pixels of the SLM be used to display the image. It is also often a requirement that display systems based on SLM devices be able to display images that are not formatted with exactly the same number of pixels as the number possessed by the SLM. For this reason it is common in the art to employ digital signal processing techniques to scale or resample the input image in order to produce an image for display that exactly matches the format of the SLM. This requires a finite, but variable time, depending on the kind of processing techniques employed, and on the number of pixels in the input image and the number of pixels possessed by the SLM.

When the requirement to digitally process the input image is considered along with the variety of SLM formats in existence, and the variety of image sequence formats that are in use, it can be readily understood by one skilled in the art that the constant and predictable behavior enjoyed when using film projection or conventional television systems of the prior art for alternate eye stereoscopic projection is not a feature possessed by a system using a digital projection display. The digital processing introduces a delay between the timing of the input image sequence and the displayed image, and the variety of input image formats result in different frame rates and frame times all of which make synchronization between the alternate eye projection sequence and the special purpose alternate eye projection viewing eyewear or an electrically switchable electro-optical polarizer in the optical path of the projector or display considerably more difficult.

### SUMMARY OF THE INVENTION

The present invention seeks to address the problem of synchronization of alternate eye projection viewing eyewear or an electrically switchable electro-optical polarizer to a digital projector used for alternate eye stereoscopic projection. Equipment and methods are disclosed for the generation of synchronization signals for alternate eye projection viewing eyewear equipped with occluding shutters or an electrically switchable electro-optical polarizer in the optical path of the projector or display used with digital image storage and retrieval systems. Equipment and methods are also disclosed for the generation of synchronization signals in the timing apparatus of a digital projection system for use with alternate eye projection viewing eyewear equipped with occluding shutters or for use with an electrically switchable electro-optical polarizer in the optical path of the projector or display. Any suitable digital projection system may benefit from the present invention, such as theatrical projection systems, digital rear projection televisions, and LCD and plasma screen digital televisions. Equipment and methods are further disclosed for the manipulation of a retrieved digital image sequence in order to ensure synchronization between the input image sequence and the alternate eye projection viewing eyewear or an electrically switchable electro-optical polarizer in the optical path of the projector or display. Equipment and methods are also disclosed for the reduction of visible artifacts and crosstalk in alternate eye stereoscopic displays.

### BRIEF DESCRIPTION OF THE DRAWINGS

FIG. 1 illustrates an exemplary embodiment of a system of synchronization of alternate eye projection viewing eyewear in a digital image projection system.

FIG. 2 illustrates an exemplary embodiment of a system of digital image projection incorporating an image storage and retrieval means and incorporating a means for the synchronization of alternate eye projection viewing eyewear.

FIG. 3 illustrates an exemplary embodiment of a digital projection system incorporating features for the synchronization of alternate eye projection viewing eyewear.

FIG. 4 illustrates an exemplary embodiment of a system of digital image storage and retrieval incorporating a means for the synchronization of alternate eye projection viewing eyewear.

FIG. 5 illustrates an exemplary embodiment of a synchronization detector for the synchronization of alternate eye projection viewing eyewear.

FIG. 6 illustrates the timing of an alternate eye stereoscopic image sequence and the associated timing of the alternate eye projection viewing eyewear.

FIG. 7 illustrates the timing of a single frame in an alternate eye stereoscopic image sequence, the associated timing of the alternate eye projection viewing eyewear and the timing of a typical digital projection system display update.

FIG. 8 illustrates the details of a typical digital projection system display update in relation to the associated timing of the alternate eye projection viewing eyewear.

FIG. 9 illustrates an exemplary embodiment of a system of digital image projection incorporating a means for reducing temporal interactions between updating of the digital image display and the timing of alternate eye projection viewing eyewear.

FIG. 10 illustrates the details of a DMD based projection system display update incorporating bit splitting in relation to the associated timing of the alternate eye projection viewing eyewear.

FIG. 11 illustrates a bit splitting technique for an alternate eye system according to one embodiment of the present invention.

FIG. 12 illustrates an exemplary graph of a typical transfer function for the input pixel values to signal processing circuitry of FIG. 9 and the resulting displayed pixel brightness from the SLM of FIG. 9 according to one embodiment of the present invention.

FIG. 13 illustrates the timing of an alternate eye stereoscopic image sequence and the associated timing of the alternate eye projection viewing eyewear and the associated timing of the image display and blanking times.

### DETAILED DESCRIPTION OF THE DRAWINGS

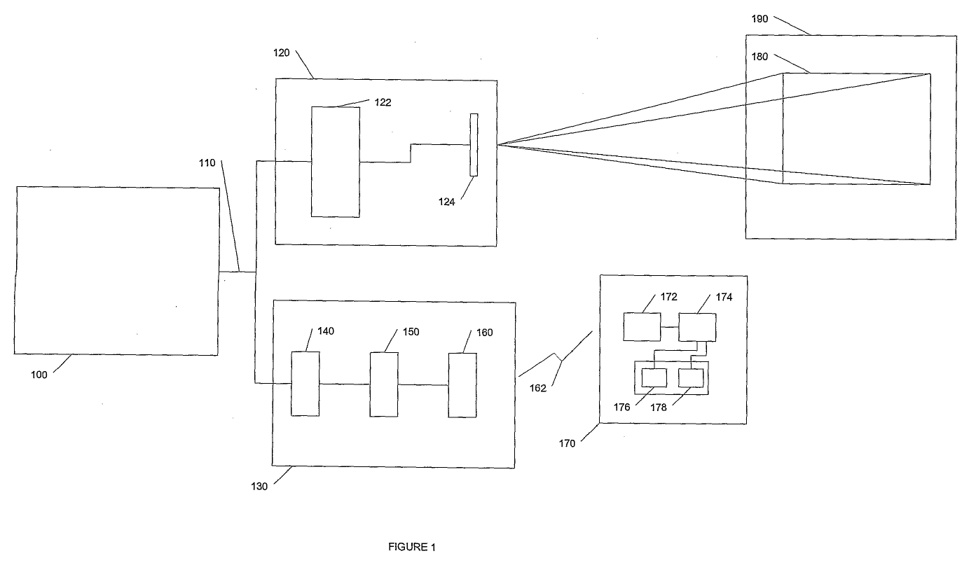

FIG. 1 illustrates in block diagram form a digital projection system including an image data storage and retrieval device 100, a projector 120, an eyewear synchronizing device 130, and eyewear 170. The individual components of the projection system can be implemented in software, hardware, or a combination of software and hardware. The image data storage and retrieval device 100 plays back stored image sequences and outputs the image sequences as image data stream 110 received by the projector 120 and also by the eyewear synchronizing device 130. Image data stream 110 is a deterministic sequence of binary data with a fixed timing pattern that includes frame synchronizing signals that indicate the start and end of each image data frame.

The image data storage and retrieval device 100 may include components such as magnetic or optical disk drives, random access memory, and digital computers. An alternate eye stereoscopic motion picture sequence may be stored as digital data on the magnetic or optical disks. This data consists of digitized data values corresponding to spatial samples of the brightness and color of the original scene. The image data is commonly organized as a series of frames in a manner analogous to motion picture film. It should be understood that in order to produce a smooth and natural illusion of continuous motion the interval between the start of each consecutive frame must be a constant value.

It is common to digitize motion picture films frame by frame and store them as digitized data. In an alternate eye projection system the sequence of frames may correspond to pairs of images with one image of each pair being the image intended for the viewer's right eye and the other image of each pair being the image intended for the viewer's left eye. Alternate eye stereoscopic motion picture image sequences may be stored as pairs of images corresponding to the left and right eye images, or as two separate sequences, one for the left eye images and one for the right eye images. Other formats for alternate eye images sequences are of course possible and will be understood by one skilled in the art.

Image data storage and retrieval device 100 may be a device specialized for the playback of digitized motion picture films, commonly called a digital media or digital cinema server. Image data storage and retrieval device 100 may also be a suitably equipped computer with magnetic or optical disk drives such as a high performance personal computer.

Image data storage and retrieval device 100 is commanded by the user through an interface such as a switch or a digital computer network interface to start and stop the playback of the stored image sequence. In addition to the image data the image data stream 110 is formatted to include data patterns or markers intended to indicate the beginning and end of each image frame. An example of a format for an image data stream is described in the Society of Motion Picture and Television Engineers (SMPTE) standard 292M-1998 Television “Bit-Serial Digital Interface for High-Definition Television Systems”.

The image data stream 110 may be used to convey other information to the devices receiving the image data stream including identification of the left and right image frames in an alternate eye stereoscopic motion picture image sequence.

FIG. 1 and other figures herein illustrate a simplified image data storage and retrieval device, but one of skill in the art would understand that the device may include other components, such as magnetic or optical disk drives, random access memory, and digital computers or digital signal processors.

In some embodiments, the eyewear 170 ensures that the viewer's right eye is only able to see the right image and the viewer's left eye is only able to see the left image in synchronization with the images being projected by the projector 120 and synchronized by the synchronization device 130.

The projector 120 includes digital signal processing circuitry 122 and a spatial light modulator (SLM) 124. FIG. 1 and other figures herein illustrate a simplified projector, but one of skill in the art would understand that the projector may include other components, such as a light source, projection lens, and relay lenses. The SLM 124 may be any suitable SLM for outputting images to a screen for display, such as deformable mirror devices (DMD) or liquid crystal devices (LCD). In other embodiments, the projector 120 has multiple SLMs.

The digital signal processing circuitry 122 receives image data stream 110 and processes each frame of the image data stream so that it may be supplied to SLM 124 for display. It is known to those skilled in the art that the format of each image frame in image data stream 110 is commonly pixel sequential where the first image pixel of the image frame corresponds to the upper left hand corner of the image with subsequent pixels corresponding to pixels in the first line of the display going from left to right and additional pixels on subsequent lines stored in the same order line by line from top to bottom of the image with the last pixel in the image frame corresponding to the right hand most pixel of the last line of the image.

It is also known to those skilled in the art that the sequence in which pixel values are supplied to the SLM may not correspond to the order in which they are supplied in image data stream 110 and as a consequence digital signal processing circuitry may be required to store or reorder the pixel values prior to supplying the pixel values to the SLM.

Digital signal processing circuitry 122 may also provide specialized timing signals, such as, for example, reset or erase signals to the SLM to control the display of images by the SLM.

In one embodiment, digital signal processing circuitry 122 identifies each image frame using the beginning and end of frame markers in the data stream 110 and extracts the pixel brightness values for each frame. The pixel brightness values are used to command the pixels of the SLM to the correct states to modulate the projection light source to the desired intensities in order to reproduce the stored image. For color images multiple SLMs may be employed such as one SLM for red, one for green and one for blue. In combination with color filters for the projection light the three SLM images are overlaid on the screen to produce a color image by additive means. Other methods are also known to those skilled in the art such as the use of a single SLM in conjunction with a color wheel containing red, green and blue sections that rotates in the projection light path to filter the light. As each of the different color wheel sections passes into the light path the corresponding pixel values for each color are supplied to the SLM by digital signal processing circuitry 122.

Digital signal processing circuitry 122 may convert or scale the format of the image data stream received from the image data storage and retrieval device 100 to the format required by SLM 124. For example, SLM 124 may have a format of 1270 pixels by 720 lines, while image data stream 110 contains image frames with a format of 1920 pixels by 1080 lines. In order to display each line of the image data stream 110 the pixels of each line in the image data stream must be resampled or decimated to a format of 1270 pixels per line. Similarly the lines of the image data stream 110 must be resampled or decimated to a format of 720 lines. Exemplary methods for performing image scaling that are well known to those skilled in the art include linear interpolation, cubic interpolation and low pass filtering followed by resampling or decimation.

High speeds or specialized voltage and signal formats are commonly used with SLM devices that result in the interface between the SLM 124 and digital processing circuitry 122 being complex and capable of implementation only over short distances. This normally requires that 122 be located in the projector with image data stream 110 being used as the external interface to the projector 120 and hence to digital processing circuitry 122. Image data formats such as the afore mentioned SMPTE standard 292M-1998 are provided with electrical interfaces suitable for implementation over longer distances such as would be found in a motion picture theatre or other location where projector 120 would be used.

As is known to one skilled in the art other types of interfaces such as NTSC analog video may be used to supply image data to projector 120, and these may require additional processing prior to being supplied to digital processing circuitry 122. This processing may be implemented externally to projector 120 or incorporated in projector 120 without departing from the spirit of the invention.

After the image data stream 110 is processed by digital processing circuitry 122 the scaled image is supplied to SLM 124. The projector 120 is capable of projecting the image formed on SLM 124 as image 180 onto screen 190. In an alternate eye stereoscopic projection system the image formed on SLM 124 and projected by projector 120 as image 180 alternates between the image intended for the viewing by the left of the viewer and the image intended for the right eye of the viewer according to the alternate eye stereoscopic image sequence supplied to projector 120 as image data stream 110 by image data storage and retrieval device 100.

The eyewear 170 includes a synchronizing signal receiver 172, a lens switching circuit 174, and lens 176, 178. The eyewear 170 is worn by viewers of the image 180 projected onto screen 190 by projector 120. The synchronizing signal receiver 172 receives the synchronizing signal 162 transmitted by a synchronizing signal transmitter 160 that forms part of eyewear synchronizing device 130. The synchronizing signal receiver 172 in turn drives lens switching circuit 174, which renders eyewear lens 176 transparent and opaque in alternation with eyewear lens 178. The synchronizing signal 162 may be transmitted by the synchronizing signal transmitter 160 to the synchronizing signal receiver 172 by a variety of methods known to those skilled in the art. The synchronizing signal 162 may be transmitted wired or wirelessly, using for example infrared or radio frequency communication with modulation or encoding methods to convey the synchronizing information in forms such as binary data patterns, frequency shifts or simple pulses schemes such as pulse width or pulse position encoding.

The processing of the image data stream 110 by digital processing circuitry 122 may delay the timing of the display of the alternate eye stereoscopic image sequence by the projector 120 with respect to the image data stream 110. Since the eyewear synchronizing device 130 is driven from the image data stream 110, the switching of the lenses in the eyewear 170 may not be synchronized to the changing of the alternate eye image sequence formed on SLM 124 and projected by projector 120 as image 180.

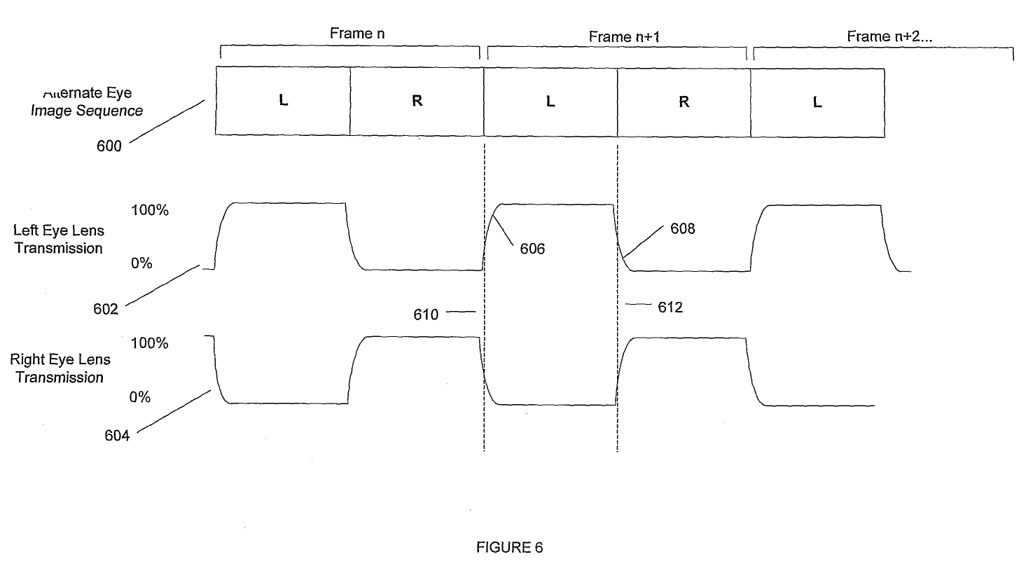

The relationship of the switching of the lenses in the eyewear 170 to the changing of the alternate eye image sequence may be understood by reference to FIG. 6 which illustrates the timing of an alternate eye stereoscopic image sequence. At 600 a typical alternate eye image sequence is shown, including left and right image pairs for each frame in the image sequence. These correspond to the frames in the alternate eye image sequence as shown in FIG. 1 where image data stream 110 is supplied to projector 120, processed by digital signal processing circuitry 122 and supplied to SLM 124 to form an image that is projected by projector 120 as image 180 onto screen 190. Returning to FIG. 6, at 602 a typical curve for the transition of the lens in the left eye position of the alternate eye projection viewing eyewear is shown with an example of the rise time from 0% transmission to 100% transmission shown at 606 and an example of the fall time from 100% to 0% at 608. At 604 a typical curve for the transition of the lens in the right eye position of the alternate eye projection viewing eyewear is shown. As indicated by the dashed line 610 there is an overlap between the transition of the lens in the left eye position of the alternate eye projection viewing eyewear from 0% to 100% and the change from the image intended for the right eye (designated by R) and the image intended for the left eye (designated by L) in the alternate eye image sequence 600. Similarly, as indicated by the dashed line 612 there is an overlap between the transition of the lens in the left eye position of the alternate eye projection viewing eyewear from 100% to 0% and the change from the image intended for the left eye (designated by L) and the image intended for the right eye (designated by R) in the alternate eye image sequence. As FIG. 6 illustrates the finite rise and fall times of the transmission of the lenses in the alternate eye projection viewing eyewear can overlap with the changes in the image sequence. This may allow light intended for one eye, for example the right eye as shown at 612 in the figure, to be seen with the left eye. This results in the condition of crosstalk or ghosting.

Because it will lead to a loss of brightness it is desirable to avoid reducing either the duty cycle of each projected image or the 100% transmission time of each lens. A compromise is therefore sought between the unwanted overlap of the two images produced by the finite rise and fall times of the transmission of the lenses in the alternate eye projection viewing eyewear and the reduction in duty cycle. In practice a small amount of overlap can be tolerated without resulting in crosstalk, and this helps to minimize the loss of brightness. The adjustment of the lens transmission times and the proper adjustment of the phase of this transmission time to the alternate eye stereoscopic image sequence are well understood for film projection.

Returning to FIG. 1 the relationship of the switching of the lenses in the eyewear 170 and the changing of the alternate eye image sequence may be adjusted by delaying the switching of the lenses in the eyewear with respect to the changing of the images between left and right projected by projector 120. An exemplary method of accomplishing this is shown in FIG. 1. In this embodiment, the synchronizing device 130 includes a frame synchronizing signal detector unit 140, a time delay unit 150, and the eyewear synchronizing signal transmitter 160. The frame synchronizing signal detector unit 140, the time delay unit 150, and the eyewear synchronizing signal transmitter 160 may be implemented in software, hardware or a combination of software and hardware. The frame synchronizing signal detector unit 140 is capable of receiving the image data stream 110 and identifying each image frame using the beginning and end of frame markers in the data stream 110. Frame synchronizing signal detector unit 140 outputs a synchronizing signal or command to time delay unit 150. Time delay unit 150 causes synchronizing signal transmitter 160 to emit a synchronizing signal after a lag or delay relative to the frame markers in image data stream 110 detected by frame synchronizing signal detector unit 140. The amount of the delay introduced by time delay unit 150 may be made adjustable in order to optimize the effect of the delay. Either the beginning or the end of frame markers in image data stream 110, or a combination may be used to trigger time delay unit 150. An example time delay unit is disclosed in U.S. Pat. No. 5,002,387, which is incorporated herein in its entirety by this reference. This time delay or lag is adjusted so that the alternate switching of the eyewear lenses 176 and 178 is matched to the actual timing of the projected image 180 after processing of the image stream data by the signal processing electronics 122 in projector 120.

In the embodiment shown in FIG. 1 when the image data format stored in image data storage and retrieval device 100 and supplied to projector 120 as image data stream 110 is changed, such that the frame time of the image sequence is changed, or the image pixel and line format is changed, such that different digital signal processing steps in projector 120 are required, a different delay will exist between the timing of input image data stream 110 and projected image 180. In order to compensate for this altered delay the delay produced by time delay unit 150 may also be changed. In the embodiment shown in FIG. 1 the synchronizing device 130 does not have information about the delays in projector 120 due to the digital signal processing required by each image data format, and so the setting of the time delay produced by unit 150 must be changed by the user through a manual adjustment process. The embodiment shown in FIG. 1 has the advantage that image data storage and retrieval device 100 and projector 120 may be standard components that are readily available from commercial suppliers, but the embodiment shown in FIG. 1 has the limitation that manual adjustment of the delay produced by time delay unit 150 may be needed each time the image format supplied to projector 120 as image data stream 110 is changed.

The need for manual adjustment can be overcome by incorporating synchronizing device 130 into projector 120 and arranging to vary the delay produced by time delay unit 150 at the same time as the digital signal processing settings in projector 120 are changed to accommodate different image data formats in image data stream 110 supplied to projector 120. This will automatically adjust the delay produced by time delay unit 150 as the image format supplied to projector 120 by image data stream 110 is changed.

Alternatively information about the delays associated with each image data format may be supplied by projector 120 to eyewear synchronizing device 130 using an additional data stream (not shown in FIG. 1) transmitted to 130 by a variety of methods known to those skilled in the art. The delay information may be transmitted wired or wirelessly, using for example infrared or radio frequency communication with modulation or encoding methods to convey the delay information in forms such as binary data patterns, frequency shifts or simple pulses schemes such as pulse width or pulse position encoding. The delay information supplied by projector 120 is then used within eyewear synchronizing device 130 to vary the delay produced by time delay unit 150. This will automatically adjust the delay produced by time delay unit 150 as the image format supplied to projector 120 in image data stream 110 is changed.

Alternatively information about the delays associated with each image data format may be stored with the image data in image data storage and retrieval device 100 and supplied as data encoded in image data stream 110 to eyewear synchronizing device 130. The delay information is then extracted by a modified frame synchronizing signal detector unit 140 and used to vary the delay produced by time delay unit 150. This information is then used to automatically adjust the delay produced by time delay unit 150 based on prior knowledge of the processing delays in projector 120 that will result from the format of the image data stored in image data storage and retrieval device 100 and supplied as image data stream 110 to projector 120.

Alternatively information about the delays associated with each image data format may be supplied separately by 100 to eyewear synchronizing device 130 by another data stream (not shown in FIG. 1) using a variety of methods known to those skilled in the art. The delay information may be transmitted wired or wirelessly, using for example infrared or radio frequency communication with modulation or encoding methods to convey the delay information in forms such as binary data patterns, frequency shifts or simple pulses schemes such as pulse width or pulse position encoding to eyewear synchronizing device 130 and in turn used within eyewear synchronizing device 130 to vary the delay produced by time delay unit 150. This information is then used to automatically adjust the delay produced by time delay unit 150 based on prior Knowledge of the processing delays in projector 120 that will result from the format of the image data stored in image data storage and retrieval device 100 and supplied as image data stream 110 to projector 120.

Alternatively information about the delays associated with each image data format may be stored with the image data in image data storage and retrieval device 100 and the components of synchronizing device 130 may be incorporated into image data storage and retrieval device 100. This information about the delays associated with each image data format may then be used within image data storage and retrieval device 100 to vary the delay produced by time delay unit 150. This will automatically adjust the delay produced by time delay unit 150 as the image format supplied to projector 120 in image data stream 110 is changed.

It should be understood that in the case where eyewear 170 is replaced by special purpose eyewear incorporating polarizing lenses used with an electrically switchable electro-optical polarizer placed in the optical path of the projector the electrically switchable electro-optical polarizer may be controlled by synchronizing device 130 to allow adjustment of the timing of the switching of the electrically switchable electro-optical polarizer with respect to the changing of the alternate eye image sequence projected by projector 120.

Because of the variety of SLMs and their different pixel and line formats it is also the case that for each projector 120 implemented with a different format SLM 124, digital signal processing circuitry 122 may be required to perform different conversion steps for different SLMs even though the format of the image data stream 110 is the same in each case. For each format of image data stream 110 this will also result in a variation in the delay between the timing of input image data stream 110 and projected image 180, in this case depending on the format of the SLM 124. This delay may also be compensated for by adjusting the delay produced by time delay unit 150 using any of the methods described herein.

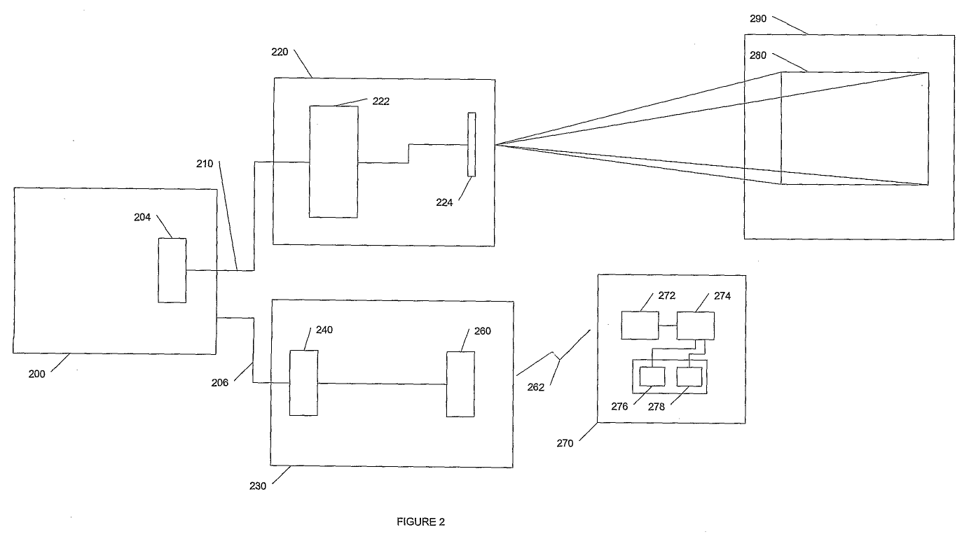

FIGS. 2-4 illustrate alternative embodiments of the digital image projection system of FIG. 1. FIG. 2 illustrates in block diagram form a digital image projection system including an image data storage and retrieval device 200 having an image data stream delay unit 204 incorporated in it for the synchronization of alternate eye projection viewing eyewear 270. The image data storage and retrieval device 200 has identical characteristics to the image data storage and retrieval device 100 of FIG. 1 and has an alternate eye stereoscopic motion picture sequence stored within it as digital data. The image data storage and retrieval device 200 outputs an image data stream 210, which is received by a projector 220, and also outputs an image data stream 206, which is received by eyewear synchronizing device 230. The characteristics of image data streams 206 and 210 are identical to image data stream 110 in FIG. 1. Projector 220 incorporates digital signal processing circuitry 222 with characteristics identical to digital signal processing circuitry 122 in FIG. 1. After the image data stream 210 is processed by digital signal processing circuitry 222 the scaled image is supplied to SLM 224. The projector 220 is capable of projecting the image formed on SLM 224 as image 280 onto screen 290. In an alternate eye stereoscopic projection system the image formed on SLM 224 and projected by projector 220 as image 280 alternates between the image intended for the viewing by the left of the viewer and the image intended for viewing by the right eye of the viewer according to the alternate eye stereoscopic image sequence supplied to projector 220 as image data stream 210 by image data storage and retrieval device 200.

The eyewear 270 worn by the viewers of the image 280 projected onto screen 290 by projector 220 receives a synchronizing signal 262 transmitted by a synchronizing signal transmitter 260 in the synchronization device 230 and received at a synchronizing signal receiver 272 associated with the eyewear 270. The synchronizing signal receiver 272 in turn drives lens switching circuit 274, which renders eyewear lens 276 transparent and opaque in alternation with eyewear lens 278. The characteristics of synchronizing signal 262 are identical to the characteristics of synchronizing signal 162 in FIG. 1.

Synchronizing device 230 includes frame synchronizing signal detector unit 240 and eyewear synchronizing signal transmitter 260. The characteristics of unit 240 and transmitter 260 are identical to the characteristics of 140 and 160 in FIG. 1.

In the embodiment shown in FIG. 2 the processing of image data stream 210 by digital signal processing circuitry 222 may delay the timing of the display of the alternate eye stereoscopic image sequence by the projector 220 with respect to the image data stream 210. Since the eyewear synchronizing device 230 is driven from the image data stream 206, the switching of the lenses in the eyewear 270 may not be synchronized to the display of the alternate eye stereoscopic image sequence by the projector 220.

Since the alternate eye stereoscopic image sequence is a regular alternation between left and right images, each cycle of switching of the lenses in eyewear 270 is identical for each left and right image pair corresponding to each pair of left and right frames from image data stream 210. Any delay of the image data stream 210 prior to supplying the image data stream to projector 220 will add to the delay produced by digital signal processing circuitry 222. If we consider the frame times required for each pair of left and right images to be one cycle, then a total delay of approximately the time required for one pair of frames from image data stream 210 will shift the phase of the image data stream 210 later in time by a full cycle. Since the switching of the lenses in eyewear 270 is identical for each left and right image pair, this method of further delaying the image signal 210 functions analogously to the time delay unit 150 of FIG. 1 and results in the proper phase relationship between the switching of the lenses in eyewear 270 display of the alternate eye stereoscopic image sequence by the projector 220.

The delay of image data stream 210 is implemented by image data stream delay unit 204 incorporated in image data storage and retrieval device 200. Delay unit 204 may be implemented in hardware, software or a combination of both. Delay unit 204 is made adjustable and acts to delay the image data stream 210 sent to projector 220 by up to one frame interval or longer. Image data stream 206 is not delayed and is sent to eyewear synchronizing device 230. Since image data stream 210 is a deterministic sequence of binary data elements with a fixed timing pattern, if delay unit 204 consists of a data storage buffer with sufficient capacity to store the number of image data elements that correspond to the desired time delay then passing the image data through delay unit 204 will result in a time delay of data stream 210. Such delay or storage buffers are well known to one skilled in the art and are readily implemented using computer memory storage.

In this embodiment information about the delays due to processing by digital signal processing circuitry 222 for each image data format may be stored with the image data in image data storage and retrieval device 200 and supplied to image data stream delay unit 204 to automatically adjust amount of the delay of image data stream 210.

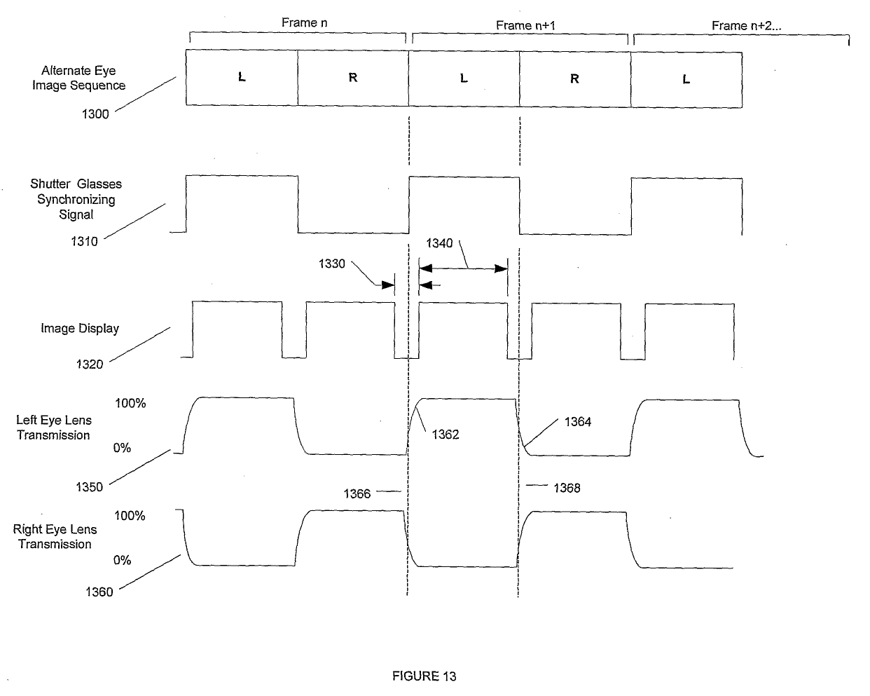

In an alternative embodiment, delay unit 204 may act only to adjust the timing of the active image data within the image data frame contained in image data stream 210. This is illustrated in FIG. 13. At 1300 a typical alternate eye image sequence is shown, including left and right image pairs for each frame in the image sequence. These correspond to the frames in the alternate eye image sequence of image data stream 210 as supplied to projector 220, as shown in FIG. 2 where image data stream 210 is processed by digital signal processing circuit 222 and supplied to SLM 224 to form an image that is projected by projector 220 as image 280 onto screen 290. Returning to FIG. 13, at 1310 an eyewear synchronizing signal is shown, corresponding to the signal output by frame synchronizing signal detector unit 240 and input to eyewear synchronizing signal transmitter 260 shown in FIG. 2. In the example of FIG. 13 the eyewear synchronizing signal output by the frame synchronizing signal detector unit is a simple square wave with a high period corresponding to the image intended for the left eye and a low period corresponding to the image intended for the right eye.

At 1350 a typical curve for the transition of the lens in the left eye position of the alternate eye projection viewing eyewear is shown with an example of the rise time from 0% transmission to 100% transmission shown at 1362 and an example of the fall time from 100% to 0% at 1364. At 1360 a typical curve for the transition of the lens in the right eye position of the alternate eye projection viewing eyewear is shown. As indicated by the dashed line 1366 there is an overlap between the transition of the lens in the left eye position of the alternate eye projection viewing eyewear from 0% to 100% and the change from the image intended for the right eye (designated by R) and the image intended for the left eye (designated by L) in the alternate eye image sequence 1300. Similarly, as indicated by the dashed line 1368 there is an overlap between the transition of the lens in the left eye position of the alternate eye projection viewing eyewear from 100% to 0% and the change from the image intended for the left eye (designated by L) and the image intended for the right eye (designated by R) in the alternate eye image sequence. As FIG. 13 illustrates, the finite rise and fall times of the transmission of the lenses in the alternate eye projection viewing eyewear can overlap with the changes in the image sequence. This may allow light intended for one eye, for example the right eye as shown at dashed line 1368 in the figure, to be seen with the left eye. This results in the condition of crosstalk or ghosting.

The image display time for each of the left and right image pairs for each frame of the alternate eye image sequence is indicated by the waveform shown at 1320 in FIG. 13. The image display time corresponds to the high level portion of the waveform 1320 as indicated by 1340, and the image blanking time corresponds to the low level portion of the waveform 1320 as indicated by 1330. The image blanking time 1330 and the image display time 1340 are determined by the digital signal processing circuit 222 in FIG. 2. During the blanking time no image data or light is projected from the SLM 224 by projector 220. As shown in FIG. 13 the image blanking time 1330 is timed such that the image from projector 220 is blanked or dark during the transition times of the lenses in the alternate eye projection viewing eyewear as indicated by dashed lines 1366 and 1368 in FIG. 13. If this blanking time is properly timed then visible overlap between the two images will be greatly reduced, resulting in reduced crosstalk or ghosting. One example of how the blanking time may be adjusted is to hold the duration of image display time 1340 constant and to phase shift the image display time 1340. This will cause the image display time 1340 to start earlier or later with respect to the eyewear synchronizing signal 1310. This will have the effect of positioning the image display time 1340 so that it does not overlap with the transitions of the lenses in the alternate eye projection viewing eyewear as indicated at dashed lines 1366 and 1368. The phase shift of the image display time may either be accomplished by adjustment of delay unit 204 or by adjusting the phase of the timing of the image display time within digital signal processing circuit 222.

Alternatively the duration of the blanking time 1330 may be directly increased or reduced and in turn this reduces or increases the image display time 1340 as required to avoid display of the image during the period where the transition times of the lenses in the alternate eye projection viewing eyewear overlap. The adjustment of the duration of blanking time 1330 may be accomplished by adjusting the blanking time and image display time produced by digital signal processing circuit 222.

Some types of SLMs require a reset or erase cycle before being updated with a new image. During the reset or erase cycle no image is displayed. In projectors that use this type of SLM the blanking time 1330 results from the reset or erase cycle. Other types of SLMs may be directly updated with new data, and for these SLMs a blanking time may be created by updating the SLM with a black image and then after a delay set to equal the desired blanking time updating the SLM with the new image. In either case the duration of the blanking time may be extended to any length that exceeds the minimum time required for the reset or erase cycle or the updating of the SLM with a black image. Of course increasing the blanking time 1330 decreases the image display time 1340, resulting in a reduction in image brightness. Also, if a constant frame rate is to be maintained the sum of the blanking time 1330 and the image display time 1340 cannot exceed the total duration of the frame time for the image format in use. Features of SLM devices that require a reset or erase cycle are well known to those skilled in the art.

Typically the adjustment of the blanking time 1330 and the image display time 1340 is accomplished using either software or hardware controls provided on the projector 220. The blanking time 1330 and the image display time 1340 may be adjusted manually while viewing a suitable alternate eye stereoscopic image sequence with the alternate eye projection viewing eyewear. The alternate eye stereoscopic image sequence is selected to maximize the chance of visual detection of ghosting or crosstalk. This may be accomplished by, for example, displaying high contrast images with significant binocular disparity or stereo depth. Such images have the characteristic that the displacement between corresponding bright areas in the image is comparatively large and this allows the bright areas of the image intended for one eye to overlap spatially with the dark areas of the image intended for the other eye. Where crosstalk exists this overlap of a bright area in one image with a dark area in the other image helps to make the crosstalk visible. The adjustment of the blanking time 1330 and the image display time 1340 may also be directly and automatically made within the projector 220 by the digital signal processing circuit 222 based on the format of the image data stream 210 supplied to projector 220 and decoded by digital signal processing circuit 222.

In this embodiment of synchronization, the delay of the image data stream 210 to the digital signal processing circuit 222 by delay unit 204 may be a fixed value with respect to the image data stream 206 being sent to the eyewear synchronizing device 230. By adjusting the blanking time 1330 and the image display time 1340, or by phase shifting the image display time 1340, the position of the image display time 1340 with respect to the eyewear synchronizing signal 1310 is adjusted. This will have the effect of positioning the image display time 1340 so that it does not overlap with the transitions of the lenses in the alternate eye projection viewing eyewear as indicated at dashed lines 1366 and 1368. Since the amount of adjustment that is practical to employ for blanking time 1330 and image display time 1340 is limited by the duration of each frame, this adjustment will serve only as a fine-tuning capability. If additional adjustment of the phase of the image display time 1340 is required then the fixed delay of delay unit 204 may also be made adjustable. Typically, the magnitude of the fixed delay is at least one frame period.

Information about the delays due to processing by digital signal processing circuitry 222 for each image data format may be stored with the image data in image data storage and retrieval device 200 and supplied to image data stream delay unit 204 to automatically adjust amount of the delay of image data stream 210.

Alternatively, information about the delays associated with each image data format may be supplied by projector 220 using a communications path, not shown in the figure, to image data storage and retrieval device 200 and in turn supplied to image data stream delay unit 204 to automatically adjust amount of the delay of image data stream 210.

It should be understood that in the case where eyewear 270 is replaced by special purpose eyewear incorporating polarizing lenses used with an electrically switchable electro-optical polarizer placed in the optical path of the projector the electrically switchable electro-optical polarizer may be controlled by synchronizing device 230 to allow adjustment of the timing of the switching of the electrically switchable electro-optical polarizer with respect to the changing of the alternate eye image sequence projected by projector 220.

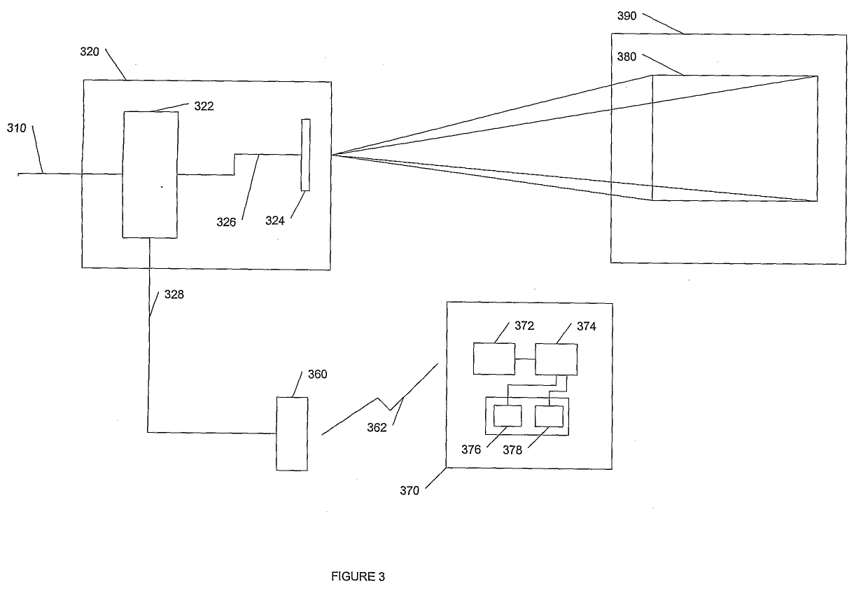

FIG. 3 illustrates another embodiment, in block diagram form, of a digital projection system incorporating features for the synchronization of alternate eye projection viewing eyewear. A projector 320 receives an image data stream 310 with characteristics identical to image data stream 110 in FIG. 1. Projector 320 incorporates digital signal processing circuitry 322 with characteristics identical to digital signal processing circuitry 122 in FIG. 1. After the image data stream 310 is processed by digital processing circuitry 322 the scaled image is supplied to SLM 324 as image data 326. The projector 320 is capable of projecting the image formed on SLM 324 as image 380 onto screen 390. In an alternate eye stereoscopic projection system the image formed on SLM 324 and projected by projector 320 as image 380 alternates between the image intended for the viewing by the left of the viewer and the image intended for the right eye of the viewer according to the alternate eye stereoscopic image sequence supplied to projector 320 as image data stream 310.

The eyewear 370 worn by the viewers of the image 380 projected onto screen 390 by projector 320 receives a synchronizing signal 362 transmitted by a synchronizing signal transmitter 360 supplied with synchronizing signal 328 from projector 320. Synchronizing signal 328 is generated by digital signal processing circuitry 322 to be synchronized with the framing of image data 326 sent to SLM 324 in projector 320. The synchronizing signal receiver 372 in turn drives lens switching circuit 374, which renders eyewear lens 376 transparent and opaque in alternation with eyewear lens 378. The characteristics of synchronizing signal 362 are identical to the characteristics of synchronizing signal 162 in FIG. 1. In this embodiment, the eyewear synchronizing signal 328 does not have any delay with respect to projected image 380 and so a delay circuit is not required. Eyewear synchronizing signal 328 may be output to drive an external synchronizing signal transmitter 360, or the synchronizing signal transmitter 360 may also be incorporated into projector 320.

An alternative embodiment eliminates the eyewear synchronizing signal within projector 320, and relies on the external synchronization circuit such as that shown at 130 in FIG. 1, but without the time delay circuit 150. In this embodiment, signal processing circuitry 322 is used to adjust the timing of the active image display within the frame interval of the projected image 380. This acts in a similar manner to the adjustable delay of FIG. 2.

It should be understood that in the case where eyewear 370 is replaced by special purpose eyewear incorporating polarizing lenses used with an electrically switchable electro-optical polarizer placed in the optical path of the projector the electrically switchable electro-optical polarizer may be controlled by synchronizing signal 328 to control the timing of the switching of the electrically switchable electro-optical polarizer with respect to the changing of the alternate eye image sequence projected by projector 320.

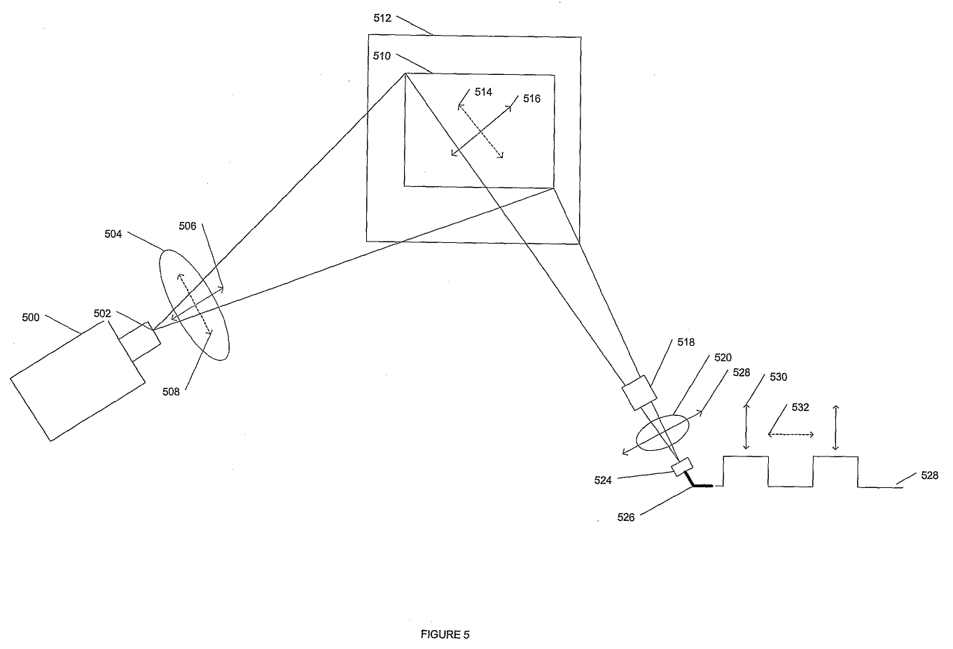

An alternative embodiment eliminates the eyewear synchronizing signal within projector 320, and relies on the external synchronization circuit such as that shown at 130 in FIG. 1, but without the time delay circuit 150. In this embodiment, the external synchronization circuit uses a photodiode or other light detector to monitor the projected image 380 and detect the transition between image frames. In situations where light images are encoded by a polarizer or other optical (e.g. spectral), temporal or spatial means within the projector or outside of the projector a detection system of this nature can also be used to detect the transition between image frames. The detected image frame transition replaces the frame synchronizing signal detected by 140 in the image data stream 110 that is supplied to 130 in FIG. 1. In this embodiment, the delay unit 150 is not required since the detected frame transition is exactly synchronized to the projected image 380. This may be understood by reference to the exemplary embodiment shown in FIG. 5.

In FIG. 5 projector 500 projects the image formed by one or more SLMs through lens 502 and electrically switchable electro-optical polarizer 504 to form image 510 on screen 512. Projector 500 corresponds to projector 100 in FIG. 1. For clarity the details of FIG. 1 have been omitted. These include an image data storage and retrieval device outputting an image data stream, an eyewear synchronizing device and eyewear all of which may be inferred from reference to FIG. 1. The state of electrically switchable electro-optical polarizer 504 may be controlled by a signal supplied by projector 500, or by a synchronizing device similar to 130 in FIG. 1. In this case the output of the synchronizing device is supplied to electrically switchable electro-optical polarizer 504 instead of to the alternate eye projection viewing eyewear.

As shown in FIG. 5, when electrically switchable electro-optical polarizer 504 is in one state the light is polarized as indicated by 506. When electrically switchable electro-optical polarizer 504 is in the other state the light is polarized opposite to the light polarized as indicated by 506. This is indicated by 508. When the polarized light reaches the screen 512 the polarization is preserved upon reflection from the screen as indicated at 514 and 516. Projection screen 512 and image 510 are viewed by collection optics 518, which collects the reflected light of image 510 from the screen 512. The light collected by 518 is directed to polarization analyzer 520. When the polarization state of the reflected light of image 510 matches the orientation of polarization analyzer 520 the light passes through 520 and reaches light detector 524. When light reaches 524 a signal 526 is output having a high and low state corresponding to waveform 528 in FIG. 5. The high state corresponds to one direction of polarization of the light 510 as indicated by 530, and the low state corresponds to the opposite direction of polarization of the light as indicated by 532. Since the state of the polarized light is determined by electrically switchable electro-optical polarizer 504 and 504 is driven in synchronization with the alternate eye stereoscopic image sequence, the signal 526 may be used to drive the lens switching circuit 274 shown in FIG. 2.

Polarizing analyzer 520 may also be replaced with other filters such as colored filters in order to use light detector 524 to detect changes in the state of the encoded light that are made in synchronization with the alternate eye stereoscopic image sequence from projector 500.

Collection optics 518 may be used to view either the entire image 510 or only a portion of the image depending on whether the encoding or modulation such as spatial or temporal modulation is present over the entire image or only a portion of the image. Collection optics 518 may also view the image light projected directly by projector 500. Collection optics 518, analyzer 520 and light detector 524 may also be incorporated in projector 500 to either view the projection screen 512 or to view a sample of the projection light within projector 500. Collection optics 518, analyzer 520 and light detector 524 may also be incorporated in or behind screen 512 in a manner that allows viewing of the image light projected by projector 500.

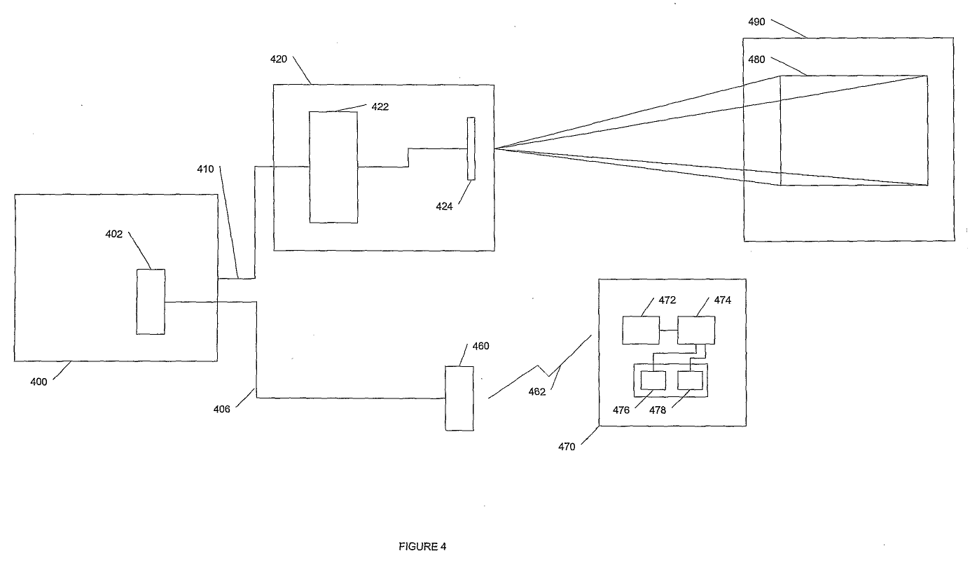

FIG. 4 illustrates another embodiment, in block diagram form, of a digital image projection system including an image storage and retrieval device 400 incorporating a system for decoding an eyewear synchronizing signal. The image data storage and retrieval device 400 outputs an image data stream 410 that is received by a projector 420. The characteristics of image data storage and retrieval device 400 and image data stream 410 are identical to image data storage and retrieval device 100 and image data stream 110 in FIG. 1. The image data storage and retrieval device 400 also outputs an eyewear synchronizing signal 406 to an eyewear synchronizing transmitter 460. Image data stream 410 is a deterministic sequence of binary data with a fixed timing pattern that includes frame synchronizing signals that indicate the start of each image data frame. Projector 420 incorporates digital signal processing circuitry 422 to convert the format of the image data stream 410 to the format required by SLM 424. Projector 420 incorporates digital signal processing circuitry 422 with characteristics identical to digital signal processing circuitry 122 in FIG. 1. After the image data stream 410 is processed by digital processing circuitry 422 the scaled image is supplied to SLM 424. The projector 420 is capable of projecting the image formed on SLM 424 as image 480 onto screen 490. In an alternate eye stereoscopic projection system the image formed on SLM 424 and projected by projector 420 as image 480 alternates between the image intended for the viewing by the left of the viewer and the image intended for the right eye of the viewer according to the alternate eye stereoscopic image sequence supplied to projector 420 as image data stream 410.

The eyewear 470 worn by the viewers of the image 480 projected onto screen 490 by projector 420 receives the synchronizing signal 462 transmitted by the synchronizing signal transmitter 460 to a synchronizing signal receiver 472 associated with the eyewear 470. The characteristics of synchronizing signal 462 are identical to the characteristics of synchronizing signal 162 in FIG. 1. The synchronizing signal receiver 472 in turn drives lens switching circuit 474, which renders eyewear lens 476 transparent and opaque in alternation with eyewear lens 478.

Image data storage and retrieval device 400 incorporates an image data stream decoder 402, which detects a specially encoded eyewear synchronizing data pattern included in the image data stored in 400. When the specially encoded eyewear synchronizing data pattern is detected by 402 an eyewear synchronizing signal 406 is output. The eyewear synchronizing data pattern is located in the image data stream at a deterministic time relative to the frame synchronizing signals in image data stream 410. The timing of eyewear synchronizing signal 406 is based on a predetermined eyewear synchronizing signal delay that is determined according to the image data format and the delay between the input image data stream 410 input to projector 420 and the projected image 480. Image data storage and retrieval device 400 may optionally delete the eyewear synchronizing signal from the image data stream prior to outputting the image data stream 410.

It should be understood that the specially encoded eyewear synchronizing data pattern may be included in the data stored in 400, or it may be added by a special process carried out inside the image data storage and retrieval device 400. Alternatively the eyewear synchronizing signal 406 may be generated internally by image data storage and retrieval device 400 by decoding internally to 400 the data stream 410 to determine the image frame timing using data patterns or markers intended to indicate the beginning and end of each image frame. This information is then used to generate the eyewear synchronizing signal 406. Additionally, the timing of eyewear synchronizing signal 406 may also be made adjustable in order to compensate for any additional variations in the timing of the system that may arise.

In the embodiment of FIG. 4 a communications path, not shown in the figure, may be used to communicate from the projector 420 to image data storage and retrieval unit 400 the amount of the delay due to processing of the image data stream 410 by digital signal processing circuitry 422 which may in turn be used to adjust the timing of eyewear synchronizing signal 406.

It should be understood that in the case where eyewear 470 is replaced by special purpose eyewear incorporating polarizing lenses used with an electrically switchable electro-optical polarizer placed in the optical path of the projector the electrically switchable electro-optical polarizer may be controlled by synchronizing signal 406 to allow adjustment of the timing of the switching of the electrically switchable electro-optical polarizer with respect to the changing of the alternate eye image sequence projected by projector 420.

In addition to the methods and apparatus of the present invention for adjusting the timing of the image display and the action of the switching of the lenses in alternate eye projection viewing eyewear or the switching of an electrically switchable electro-optical polarizer in order to reduce crosstalk and ghosting artifacts in alternate eye stereoscopic image sequences, the timing of the updating of the SLM display may also be modified as will now be described in order to reduce crosstalk and ghosting artifacts.

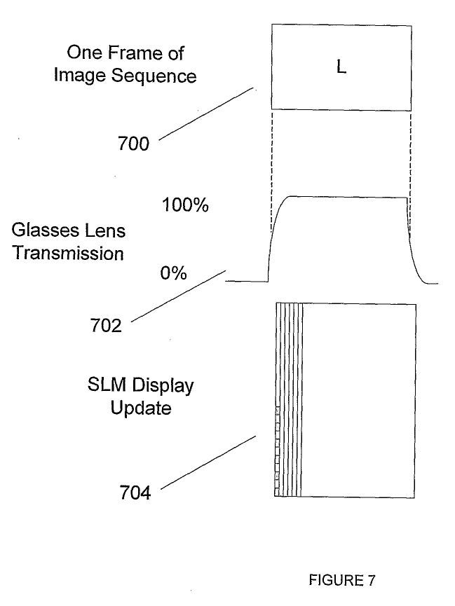

FIG. 7 illustrates at 700 a single frame of the alternate eye stereoscopic image sequence, in this case the image intended for the left eye and a typical transmission curve for the transition of the shutter in the left eye position of the alternate eye projection viewing eyewear is shown at 702. Below the curve 702 at 704 is a diagram of the updating of a single frame of a SLM display, in this case shown rotated 90 degrees so that the vertical axis of the image display is horizontal in the figure.

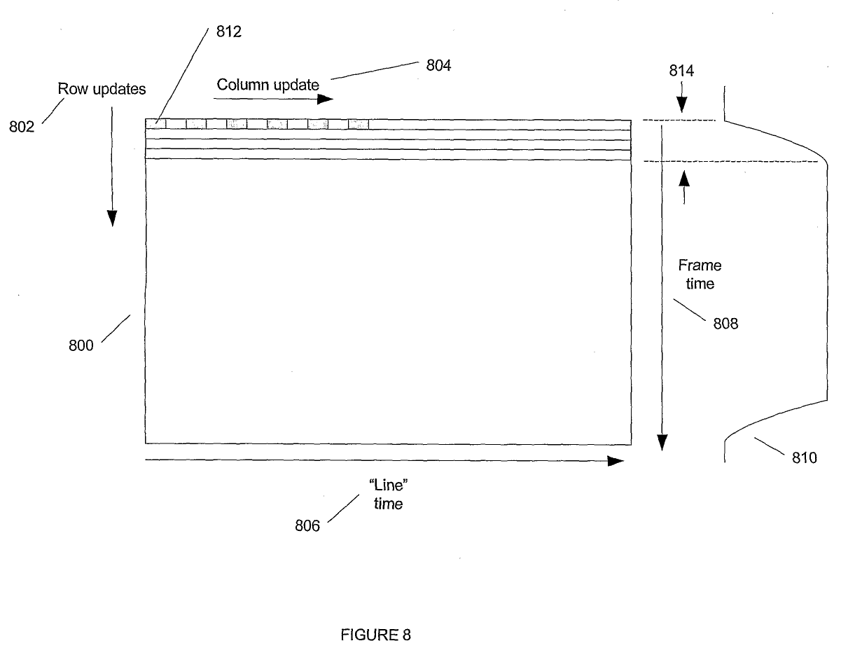

FIG. 8 illustrates the same single updating of a single frame of an SLM display at 800, corresponding to 704 in FIG. 7, but in this case rotated back to the conventional orientation with the vertical axis of the display vertical in the figure. At 802 the conventional display row update direction is illustrated, and at 804 the conventional column update direction is illustrated. The time for updating one entire row of the display is illustrated by 806, and the time for updating of the entire display is illustrated by 808. At 810 the typical transmission curve for the transition of the shutter in the left eye position of the alternate eye projection viewing eyewear is shown that corresponds to the curve at 702 in FIG. 7, but in this case rotated by 90 degrees.

FIG. 8 illustrates the relationship between the typical transmission curve for the transition of the shutter in the left eye position of the alternate eye projection viewing eyewear and the updating of a SLM display. As can be appreciated by reference to FIG. 6, the same timing relationship will exist for the typical transmission curve for the transition of the shutter in the right eye position of the alternate eye projection viewing eyewear and the updating of a SLM display. It should also be understood that the display may be a DMD based display, or a display based on a liquid crystal SLM such as a liquid crystal on silicon or LCOS reflective display.

Typically an LCOS display is updated by addressing the cells of the LCOS display using a row and column multiplexing arrangement. Each LCOS pixel has an associated capacitor, and the row and column multiplexer is used to connect each pixel in turn to the output of a digital to analog converter or DAC via suitable analog drive circuits. The digital data presented to the DAC represents the desired brightness value for the pixel. The pixel to be updated is addressed by the row and column multiplexer and the DAC changes the charge stored in the pixel to the value appropriate to represent the desired pixel brightness value. In a practical implementation a number of DACs are used to drive a number of pixels in the same row at the same time in order to support higher frame rates for the display. This updating is illustrated by the alternating gray and white rectangles across the column axis as at 812 in FIG. 8. Each rectangle signifies the number of pixels in that row that are updated together, for example 8 pixels at a time may be set to the desired values using 8 DAC circuits.

Since a typical high quality LCOS display device may have 2048 pixels per line and more than 1080 lines, and since a DAC and associated analog drive circuits will require a finite time to propagate a display update to each pixel in the display in can be appreciated that the updating of the LCOS display will require some amount of time to complete. As FIG. 8 also shows, the finite rise time at 814 of the transmission curve 810 for the transition of the shutter in the left eye position of the alternate eye projection viewing eyewear overlaps with the updating process of the LCOS display. It should be understood that if the display updating proceeds throughout the frame time 808 that a similar overlap will exist for the fall time of the transmission curve 810 for the transition of the shutter in the alternate eye projection viewing eyewear.

If the LCOS display is updated in the usual fashion, starting at the upper left corner in the figure and proceeding across each row, it can be see that pixel positions on the display are analogous to time in a fashion similar to the scanning of a cathode ray tube in a television display. In fact this convention is apt as all existing and newly developed video and computer sources provide pixels in a sequential order as if they were to be displayed on a cathode ray tube. However, it should be understood that the pattern of updating the display may be any arbitrary pattern as dictated by the design of the LCOS display driving circuitry and pixel multiplexing arrangement.

In light of the previous discussion of the problem of the finite rise and fall times, the desirability of minimizing crosstalk between the left and right image pairs and the desirability of maintaining maximum image brightness it is important to consider the relationship between the display updates and the switching of the alternate eye projection viewing eyewear.

What one can understand from FIG. 8 is that the shuttering action of the alternate eye projection viewing eyewear switching from 0% to 100% will interact with the early pixels in the display update. Although the update pattern shown suggests that these early pixels will be at the top of the display it should be understood that this interaction will occur regardless of where on the display the update pattern begins. The temporal interaction between the shuttering action of the alternate eye projection viewing eyewear and the display update will result in a visual effect similar to that of a stroboscope, revealing the update process and causing a structure to appear in the image that would otherwise not be noticed. Similar effects have been noted with other types of SLM devices such as DMDs, which are commonly updated in a column order with groups of pixels receiving the mirror position commands simultaneously from a memory plane associated with the DMD display. It should be understood that this interaction is due to the point in time where the display updating begins and ends with respect to the timing of the switching of the alternate eye projection viewing eyewear and not with respect to the position on the display that is being updated.

Since the shutter is making a transition from 0% transmission to 100% transmission at the beginning of the frame time 808, pixel values corresponding to visible artifacts will be relatively bright while pixels that are dim will not be particularly visible during the shutter transition.

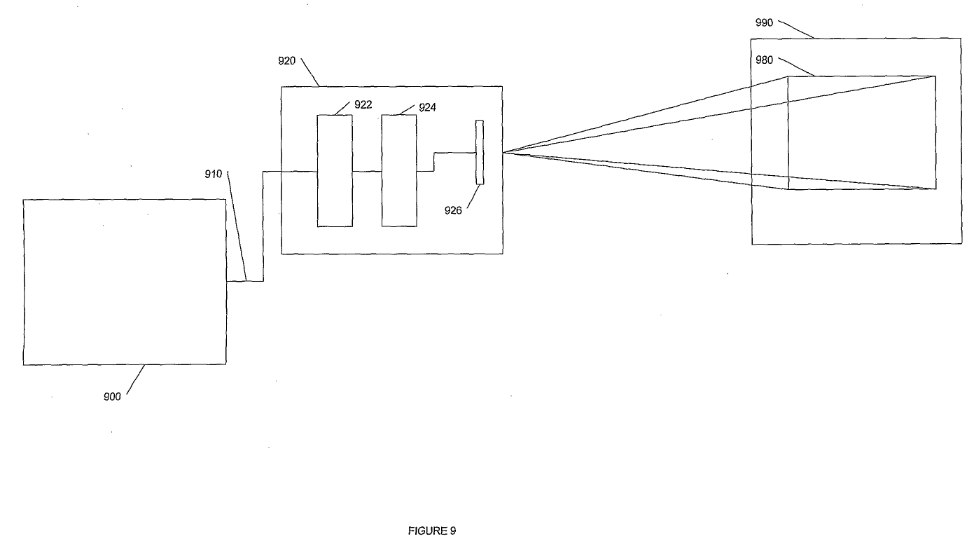

FIG. 9 illustrates in block diagram form a projection system incorporating features that minimize the visibility of the artifacts produced by temporal interaction between alternate eye projection viewing eyewear and an SLM based display. An image data storage and retrieval device 900 outputs an image data stream 910 received by a projector 920. For clarity the details of the eyewear synchronizing device and eyewear are omitted but they may be inferred from reference to FIG. 1. Image data stream 910 is a deterministic sequence of binary data with a fixed timing pattern that includes frame-synchronizing signals that indicate the start of each image data frame. Projector 920 incorporates frame storage unit 922 that receives the image data from image data stream 910 and digital signal processing circuitry 924 to convert the format of the image data stream 910 from the format of storage unit 922 to the format required by SLM 926. Projector 920 projects the image formed on SLM 926 as image 980 onto screen 990.

In this embodiment digital signal processing circuitry 924 reads out the image data from the frame storage unit 922, which is a random access addressable memory of the type well known in the art. SLM 926 is also addressable for the updating of pixel values by digital signal processing circuitry 924 in a random access fashion. With this arrangement, the reading out of the frame storage unit 922 and the updating of SLM 926 does not have to proceed in a sequential manner corresponding to the update pattern shown at 802 and 804 in FIG. 8. By programming digital signal processing circuitry 924 to alter the pattern of the display updating it is possible to reduce or eliminate the temporal interaction between the alternate eye projection viewing eyewear and the updating of SLM 926.

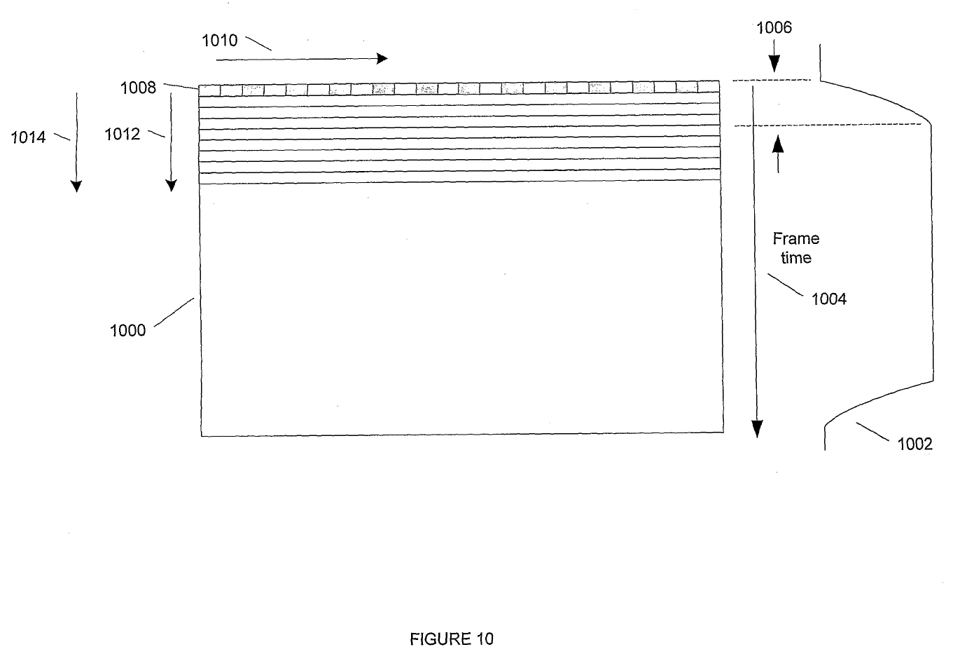

This is further illustrated in FIG. 10. The SLM display at 926 in FIG. 9 is illustrated by 1000, with the column updating shown by the alternating gray and white rectangles across the column axis as at 1008. The column updating direction is indicated by 1010, and the frame time by 1004 with the corresponding transmission curve 1002 for the transition of the shutter in the alternate eye projection viewing eyewear. The temporal overlap of the frame time with the finite rise time of the shutter in the alternate eye projection viewing eyewear from 0% to 100% transmission is illustrated at 1006. By modifying the pixel values sent to the SLM 924 in FIG. 9 at the beginning of the frame time to lesser values than some threshold, the visibility of artifacts due to the overlap 1006 will be reduced. For example, 1012 represents the initial updating of successive rows of the display 1000 where the maximum brightness of column locations in the overlap time period 1006 are updated to the threshold value chosen to minimize the visibility of the artifacts. After the overlap time 1006 has passed the random access to the display 1000, corresponding to SLM 926 in FIG. 9, by digital signal processing circuitry 924 is used to update pixels with values above the threshold value to their final values from frame store 922 through another update cycle 1014.

It should be understood that the illustration of FIG. 10 is not intended to represent the exact timing of any particular display updating or the exact response of any particular shutter used in alternate eye projection viewing eyewear, but merely serves to indicate the timing relationships. It should also be understood that there are other patterns of updating that may be optimal to achieve a minimization of the visibility of artifacts due to the temporal interaction between alternate eye projection viewing eyewear and an SLM based display and these may be employed without departing from the spirit of the invention.

It should also be understood that if the fall time of the transmission curve 1002 for the transition of the shutter in the alternate eye projection viewing eyewear should overlap with the beginning of the next display update, intended for the other eye of the viewer, crosstalk will occur, and this crosstalk will also be reduced in its visibility due to the reduced intensity values being applied at the beginning of the display update for the frame intended for the other eye. This may be understood to be similar in its effects to the image processing intended to reduce crosstalk as described in U.S. Pat. No. 6,765,568 to Swift et al. but as can be appreciated the method of the instant invention is designed to minimize the visibility of both temporal artifacts and crosstalk without processing of the images prior to display as required by Swift. Additionally, the instant invention has the advantage of restoring the brightness of the affected regions of the display as soon as the period of overlap 1006 has ended.

It should be understood that in some cases it may be an advantage to have multiple threshold values. For example a first threshold value that is applied with respect to pixel values where the corresponding pixel locations are updated early or late in the image display time period and a second threshold value that is applied with respect to pixel values where the corresponding pixel locations are updated closer to the center of the image display time period.

Determination of the threshold value may be made using either subjective or objective techniques. Subjective determination may be made by providing for manual adjustment of a threshold value or values while viewing a suitable alternate eye stereoscopic image sequence with the alternate eye projection viewing eyewear. The alternate eye stereoscopic image sequence is selected to maximize the chance of visual detection of interactions between the display update and the alternate eye projection viewing eyewear. This may be accomplished by displaying high contrast images with significant binocular disparity or stereo depth. Such images have the characteristic that the displacement between corresponding bright areas in the image is comparatively large and this allows the bright areas of the image intended for one eye to overlap spatially with the dark areas of the image intended for the other eye. Where crosstalk exists this overlap of a bright area in one image with a dark area in the other image helps to make the crosstalk visible. Temporal artifacts may also be noticed with an image of this type, or it may be preferable to use an image having low contrast gray scale or color images with values selected to correspond to the most noticeable levels of temporal interaction between the display update and the alternate eye projection viewing eyewear. These image values may be initially determined by psychophysical experimentation as will be understood by one skilled in the art.

Objective determination may be made by providing a suitable alternate eye stereoscopic image sequence and monitoring the display with a light detector or a camera system coupled to a signal or image analyzing system. The system may be programmed to automatically test various settings for each threshold value or values and determine the settings that minimize crosstalk and temporal artifacts as established by objective measures such as the minimum detectable contrast for the human visual system.

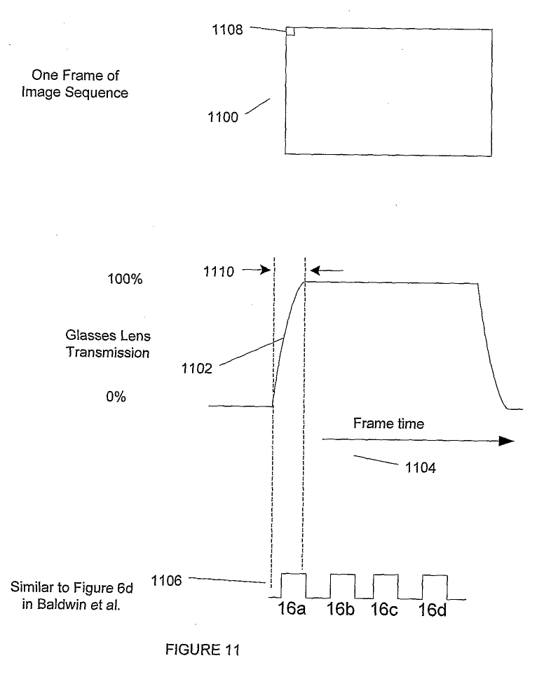

For SLM based displays using DMDs, the method of producing a gray scale is based on time division modulation as described in U.S. Pat. No. 5,986,640 to Baldwin et al., which is incorporated herein in its entirety by reference. As described in Baldwin et al. this method of producing a gray scale has the limitation that artifacts can arise in the image due to temporal effects from the time division modulation. In order to minimize such artifacts, Baldwin et al. describe a method of temporally balancing the time division modulation using a technique called “bit splitting”. FIG. 11 illustrates a bit splitting technique for an alternate eye system according to one embodiment of the present invention. A single frame of the alternate eye stereoscopic image sequence is shown at 1100. At 1102 a typical transmission curve for the transition of the shutter of alternate eye projection viewing eyewear is shown. Corresponding to the curve 1102 is the frame time 1104 for the displayed image 1100. At 1108 a bright pixel of the display 1100 is indicated that receives the time division modulation pattern at 1106 that corresponds to the most significant bit of the bit splitting pattern shown in FIG. 6d of Baldwin et al. As described in Baldwin et al. this bit splitting pattern is performed over the full time duration of a single frame time 1104. As can be seen in FIG. 11 the rise time 1110 of the transmission curve for the transition of the shutter of alternate eye projection viewing eyewear overlaps with the pattern 1106. As can be appreciated a temporal interaction will result that will have a visual effect similar to that of a stroboscope, revealing the update process and causing a structure to appear in the image that would otherwise not be noticed. This leads to noticeable and disturbing artifacts in the display variously described as blinking, crawling, jitter or brightness contouring. It should be understood that these artifacts will arise due to the timing of the bit splitting pattern with respect to the timing of the shutter glasses transition regardless of where on the display the bit splitting pattern is displayed.

In the case where the SLM 926 of FIG. 9 is a DMD device, the digital signal processing circuitry 924 can incorporate bit splitting techniques, such as those described in Baldwin et al. and by, for example, adjusting the bit splitting patterns to avoid the overlap between the high order bits and the shutter glasses transition as illustrated at 1110 in FIG. 11 the visibility of the artifacts may be reduced.

Of course, the principles of Baldwin et al. for controlling the visibility of artifacts due to bit splitting cannot be ignored, but it can now be appreciated that certain bit splitting patterns may be better suited to alternate eye displays. In particular, the higher order bits may be placed nearer the center of the frame time period to reduce the chances of overlap between the bit splitting pattern and the transitions of the shutter of alternate eye projection viewing eyewear. Since this will affect the brighter pixels it can also be appreciated that this will act to reduce the visibility of crosstalk in a manner similar to that already disclosed in reference to FIG. 10.

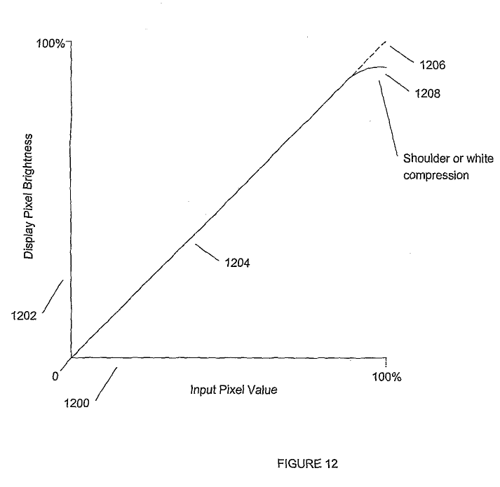

In SLM displays, where the methods and apparatus of the invention illustrated in FIG. 9 are applied, it is possible that the effective reduction in the time period for display of the brightest pixel values in the image will cause a small compression of white portions of the image. This may be understood by referring to FIG. 12 where a graph illustrates a typical transfer function between the input pixel values to signal processing circuitry 924 in FIG. 9 and the resulting displayed pixel brightness from the SLM 926 in FIG. 9. The horizontal axis 1200 corresponds to the input pixel values ranging from 0 to 100% of full scale. The vertical axis 1202 corresponds to the displayed pixel brightness ranging from 0 to 100% of full scale. The curve 1204 shows the relationship or transfer function between the input pixel values and the displayed pixel brightness. The dashed line at 1206 shows the portion of the transfer function 1204 that may be modified by the methods and apparatus of the invention illustrated in FIG. 9. The reduction in time period for the display of the brightest pixel values in the image will result in the “shoulder” or white compression indicated by the curve at 1208. The curve at 1208 shows the effect of reducing the effective on time for the bright pixels starting at approximately 90% of full scale. If the time reduction is proportional to the pixel value, then the transfer function should have an asymptotic shape similar to that produced by the white compression often required when transferring wide dynamic range (film) images to SLM based displays. This will provide an additional benefit of reducing the effects of clipping in the brightest portions of the image that is often a problem encountered in SLM based displays.

For SLM displays based on LCOS devices methods similar to Baldwin et al. may be used for production of a gray scale based on time division modulation as described for example in U.S. Patent Application No. 2003/0210257 to Hudson et al. For displays using LCOS devices with time division modulation for production of a gray scale the methods and apparatus of FIG. 9 may also be employed for the reduction of the visibility of artifacts due to the temporal interaction between alternate eye projection viewing eyewear and the SLM display.

It should be understood that the methods and apparatus of FIG. 9 may also be applied to alternate eye projection systems using special purpose eyewear incorporating polarizing lenses used with an electrically switchable electro-optical polarizer placed in the optical path of the projector. In this case the temporal interaction occurs between the SLM display updating and the electrically switchable electro-optical polarizer and the same methods and apparatus are effective to reduce the visibility of artifacts due to the temporal interaction between the electrically switchable electro-optical polarizer and the SLM display.

The foregoing description of embodiments of the invention has been presented only for the purpose of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments with various modifications as are suited to the particular use contemplated. For example, the principles of this invention can be applied to a single projector, two or more projectors, and to projectors arranged in configurations where a composite image is produced from a matrix of images arranged horizontally, vertically or both. The invention can also be applied to direct view displays including SLM based displays, plasma displays and other types of direct view display. The present invention is intended to embrace all such alternative configurations, all of which can be implemented without departing from the spirit of the present invention. Any suitable digital projection system may benefit from the present invention, such as theatrical projection systems, digital rear projection televisions, and LCD and plasma screen digital televisions.

That which is claimed is:

1. A projection system comprising at least one projector for projecting alternate left and right eye stereoscopic images for viewing with stereoscopic viewing eyewear, comprising:
an image data storage and retrieval device capable of outputting an image data stream in a first image data format;
a projector capable of producing displayed image frames for viewing and having at least one spatial light modulator and a signal processing unit capable of receiving the image data stream and converting the first format to a second image data format, wherein the second image data format is compatible with the at least one spatial light modulator; and
a synchronizing device comprising a frame synchronizing signal detector, a time delay unit, and a synchronizing signal transmitter, wherein the frame synchronizing signal detector is capable of generating a synchronization signal for synchronizing the eyewear with the displayed image frames, the synchronizing signal transmitter is capable of transmitting the synchronization signal, and the time delay unit is capable of causing a time delay for transmission of the synchronizing signal based at least in part on either or both of the first image format and the second image data format.

2. The system of claim 1, wherein the first image data format contains information that can be decoded by the frame synchronizing signal detector and used to vary the time delay of the time delay unit.

3. The system of claim 1, wherein the synchronizing device receives delay information from the signal processing unit.

4. The system of claim 1, wherein the synchronizing device receives delay information from the data storage and retrieval device.

5. The system of claim 1, wherein the synchronization signal is used to synchronize shuttering of the stereoscopic viewing eyewear to the displayed image frames.

6. The system of claim 1, wherein the synchronization signal is used to synchronize an electrically switchable electro-optical polarizer placed in front of a display or a projection lens.

7. A projection system comprising at least one projector for projecting alternate left and right eye stereoscopic images for viewing with stereoscopic viewing eyewear, comprising:
an image data storage and retrieval device capable of outputting an image data stream in a first image data format;
a projector capable of producing displayed image frames for viewing and having at least one spatial light modulator and a signal processing unit capable of receiving the image data stream and converting the first format to a second image data format, wherein the second image data format is compatible with the at least one spatial light modulator;
an image data delay unit for delaying the image data stream to the projector by a delay period, wherein the delay period is adjustable;
a synchronizing device comprising a frame synchronizing signal detector, and a synchronizing signal transmitter, wherein the frame synchronizing signal detector is capable of generating a synchronization signal for synchronizing the eyewear with the displayed image frames, and the synchronizing signal transmitter is capable of transmitting the synchronization signal, wherein the synchronizing device synchronizes to the image data stream prior to the image data stream being delayed by the image delay unit.

8. The system of claim 7, wherein the first image data format contains information that can be decoded and used to vary a time delay of the image data delay unit.

9. The system of claim 7, wherein the synchronization signal is used to synchronize shuttering of the stereoscopic viewing eyewear to the displayed image frames.

10. The system of claim 7, wherein the synchronization signal is used to synchronize an electrically switchable electro-optical polarizer placed in front of a display or a projection lens.

11. The system of claim 7, wherein the image data delay unit only delays the timing of active image data within each image data frame contained in the image data stream.

12. The system of claim 7, wherein the displayed image frames are temporally shifted with respect to the synchronization signal by temporally shifting a dark interval between subsequent image frames and wherein the temporal shifting is done in the image data delay unit or in the signal processing unit.

13. The system of claim 12, wherein the dark interval is an adjustable period.

14. The system of claim 7, wherein the image data delay unit is contained within the signal processing unit.

15. A projection system comprising at least one projector for projecting alternate left and right eye stereoscopic images for viewing with stereoscopic viewing eyewear comprises of:
an image data storage and retrieval device capable of outputting an image data stream in a first image data format;
a projector capable of producing displayed image frames for viewing and having at least one spatial light modulator and a signal processing unit capable of receiving the image data stream and converting the first format to a second image data format, wherein the second image data format is compatible with the at least one spatial light modulator; and
a signal processing unit capable of outputting a synchronizing signal, wherein the synchronization signal does not have any delay with respect to the displayed image frames.

16. The system of claim 15, wherein the synchronization signal is used to synchronize shuttering of the stereoscopic viewing eyewear to the displayed image frames.

17. The system of claim 15, wherein the synchronization signal is used to synchronize an electrically switchable electro-optical polarizer placed in front of a display or a projection lens.

18. A projection system comprising at least one projector for projecting alternate left and right eye stereoscopic images for viewing with stereoscopic viewing eyewear, comprising:
an image data storage and retrieval device capable of outputting an image data stream;
a projector capable of producing displayed image frames for viewing and having at least one spatial light modulator; and
a synchronization unit comprising a transition detector capable of monitoring the displayed image frames and detecting a transition between displayed image frames, wherein the synchronization unit is capable of producing a synchronization signal based at least in part on the transition.

19. The system of claim 18, wherein the synchronization unit is within the projector.

20. The system of claim 18, wherein the transition detector is a light detector and detects the transition by detecting a change in light of the displayed image frames.

21. The system of claim 18, wherein the displayed image frames are encoded by a polarizer and the transition detector detects image transitions resulting from a change in image polarization.

22. The system of claim 18, wherein the displayed image frames are encoded by optical, temporal, or spatial means that are used by the transition detector to detect image transition.

23. A projection system comprising at least one projector for projecting alternate left and right eye stereoscopic image frames for viewing with stereoscopic viewing eyewear, comprising:
an image data storage and retrieval device capable of outputting an image data stream in a first image data format; and
a projector capable of producing displayed image frames for viewing and having at least one spatial light modulator and a signal processing unit capable of receiving the image data stream and converting the first format to a second image data format, wherein the second image data format is compatible with the at least one spatial light modulator,
wherein the image data stream is encoded with a synchronization data specific to synchronize the displayed image frames, and wherein the image data storage and retriever device comprises an image data stream decoder unit capable of detecting the encoded synchronization data and producing a synchronization signal.

24. The system of claim 23, wherein the synchronization signal is used to synchronize shuttering of the stereoscopic viewing eyewear to the displayed image frames.

25. The system of claim 23, wherein the synchronization signal is used to synchronize an electrically switchable electro-optical polarizer placed in front of a display or a projection lens.

26. The system of claim 23, wherein the encoded synchronization data is removed from the image data stream before the image data stream goes to the signal processing unit.

27. The system of claim 23, wherein the encoded synchronization data is included in the image data stream stored in the image storage and retrieval device.

28. The system of claim 23, wherein the encoded synchronization data is encoded in the image data stream prior to being received by the image data storage and retrieval device.

29. The system of claim 23, wherein timing of the synchronizing signal is adjusted prior to the encoded synchronization data being encoded.

30. A projection system comprising at least one projector for projecting alternate left and right eye stereoscopic images for viewing with stereoscopic viewing eyewear, comprising:
an image data storage and retrieval device capable of outputting an image data stream in a first image data format;
a projector capable of producing displayed image frames for viewing and having at least one spatial light modulator for producing the displayed image frames based at least in part on pixel values associated with the image data stream;
a frame storage unit capable of receiving a first image data format and storing the image data in the first image format;
a signal processing unit capable of reading out the first image data format from the frame storage unit in any pattern and converting the first image data format to a second image data format, wherein the second image data format is compatible with the at least one spatial light modulator;
a means for selectively modifying the pixel values supplied to the spatial light modulator according to a threshold value, wherein the threshold value is associated with the first or second image data format; and
a synchronizing device comprising a frame synchronizing signal detector, a time delay unit, and a synchronizing signal transmitter, wherein the frame synchronizing signal detector is capable of generating a synchronization signal for synchronizing the eyewear with the displayed image frames, the synchronizing signal transmitter is capable of transmitting the synchronization signal, and the time delay unit is capable of causing a time delay for transmission of the synchronizing signal based at least in part on either or both of the first image format and the second image data format.

31. The system of claim 30, wherein the first image data format contains information that can be decoded by the frame synchronizing signal detector and used to vary the time delay of the time delay unit.

32. The system of claim 30, wherein the synchronizing device receives delay information from the signal processing unit.

33. The system of claim 30, wherein the synchronizing device receives delay information from the data storage and retrieval device.

34. The system of claim 30, wherein the synchronization signal is used to synchronize shuttering of the stereoscopic viewing eyewear to the displayed image frames.

35. The system of claim 30, wherein the synchronization signal is used to synchronize an electrically switchable electro-optical polarizer placed in front of a display or a projection lens.

36. The system of claim 30, wherein modification of timing of gray scale time division modulation patterns used to drive the spatial light modulator is determined according to a threshold value at which crosstalk between the left and right image frames is minimized.

37. The system of claim 30, wherein modification of timing of gray scale time division modulation patterns used to drive the spatial light modulator is determined according to a desired amount of brightness compression desired for pixels above a threshold value in the displayed image frames.

38. A projection system comprising at least one projector for projecting alternate left and right eye stereoscopic images for viewing with stereoscopic viewing eyewear, comprising:
an image data storage and retrieval device capable of outputting an image data stream in a first image data format;
a projector capable of producing displayed image frames for viewing and having at least one spatial light modulator for producing the displayed image frames based at least in part on pixel values associated with the image data stream;
a frame storage unit capable of receiving a first image data format and storing the image data in the first image format;
a signal processing unit capable of reading out the first image data format from the frame storage unit in any pattern and converting the first image data format to a second image data format, wherein the second image data format is compatible with the at least one spatial light modulator;
a means for selectively modifying the pixel values supplied to the SLM according to the threshold value, wherein the threshold value is associated with the first or second image data format;
a means for generating gray scale patterns according to the pixel values using time division modulation by driving pixels of the spatial light modulator between on and off states at sub-frame rates;
a means for selectively modifying timing of the gray scale time division modulation patterns used to drive the spatial light modulator according to the threshold value; and
a synchronizing device comprising a frame synchronizing signal detector, a time delay unit, and a synchronizing signal transmitter, wherein the frame synchronizing signal detector is capable of generating a synchronization signal for synchronizing the eyewear with the displayed image frames, the synchronizing signal transmitter is capable of transmitting the synchronization signal, and the time delay unit is capable of causing a time delay for transmission of the synchronizing signal based at least in part on either or both of the first image format and the second image data format.

39. The system of claim 38, wherein the first image data format contains information that can be decoded by the frame synchronizing signal detector and used to vary the time delay of the time delay unit.

40. The system of claim 38, wherein the synchronizing device receives delay information from the signal processing unit.

41. The system of claim 38, wherein the synchronizing device receives delay information from the data storage and retrieval device.

42. The system of claim 38, wherein the synchronization signal is used to synchronize shuttering of the stereoscopic viewing eyewear to the displayed image frames.

43. The system of claim 38, wherein the synchronization signal is used to synchronize an electrically switchable electro-optical polarizer placed in front of a display or a projection lens.

44. The system of claim 38, wherein modification of timing of the gray scale time division modulation patterns used to drive the spatial light modulator is determined according to a threshold value at which crosstalk between the left and right image frames is minimized.

45. The system of claim 38, wherein modification of the timing of the gray scale time division modulation patterns used to drive the spatial light modulator is determined according to a desired amount of brightness compression desired for pixels above a threshold value in the displayed image frames.
